(19) United States
(12) Patent Application Publication
(10) Pub. No.: US 2023/0267423 A1
(43) Pub. Date: Aug. 24, 2023

(54) SYSTEMS AND METHODS FOR SERVER-BASED CALENDAR EVENT INFORMATION STORAGE AND RETRIEVAL

(71) Applicant: Tommy Wagner, Manila, AR (US)

(72) Inventor: Tommy Wagner, Manila, AR (US)

(21) Appl. No.: 18/303,774

(22) Filed: Apr. 20, 2023

Related U.S. Application Data
(60) Provisional application No. 63/312,266, filed on Feb. 21, 2022.

(51) Int. Cl. G06Q 10/1093

(52) U.S. Cl. CPC G06Q 10/1095

(57) ABSTRACT

Provided herein is an electronic calendar platform (“ECP”) server programmed to receive, from a user application, a subscription request identifying an event manager, and create a subscription record in a database. The server is also programmed to receive, from a manager application, calendar event information including a scheduled date/time for each of a plurality of events, and create, in the database, a plurality of event records linked to the event manager ID. Additionally, the server is programmed to receive, from the user application, a populate request configured to populate a calendar event feed displayed by the user application, and in response to the populate request, query the database for event records associated with event managers and the user, generate an ordered sequence of the calendar event information for the events returned by the query, and transmit the ordered sequence to the user application for display in the calendar event feed.

### CROSS REFERENCE TO RELATED APPLICATIONS

This application claims priority to U.S. Provisional Application No. 63/312,266, filed Feb. 21, 2022, which is hereby incorporated by reference in its entirety.

### FIELD OF THE DISCLOSURE

The present disclosure relates to database sourced electronic calendar platforms and, more particularly, to systems and methods for server-based storage and retrieval of calendar event information and configured to present the calendar event information to a user by a calendar event feed on a user device associated with the user and to selectively transmit notifications and reminders of the calendar event information to the user device.

### BACKGROUND

Conventional electronic calendar platforms have enabled a user to organize personal event information (e.g., date/time of an upcoming birthday, holiday, or work deadline) into a digital calendar stored on an electronic device associated with the user, such as a smartphone. Conventional electronic platforms have also enabled a user to subscribe to calendars associated with event managers (e.g., school administrators, teachers, sporting team coaches, and/or social event organizers) and to import event information from the event managers' calendars (e.g., date/time of an upcoming parent teacher conference, school meeting, sporting event, social gathering) into the user's digital calendar. Typically, electronic calendar platforms store a calendar event object on each user's computing device, and present a user's digital calendar in standard month/day format. While this provides a familiar interface for a user, such conventional systems have a storage and interface structure that forces the user to store, organize, and view calendared events in standard calendar units, for example on a per day, per week, or per month basis. The user may have a large amount of event information associated with a given day/week/month, which consumes the user's digital storage resources. For example, if ten users calendar the same event, the calendar event object is conventionally stored separately by the ten corresponding computing devices of those users. Moreover, in order to focus attention on information related to important events that the user would like to prioritize, the user must mentally sift through the all the information presented for that day/week/month on the calendar. Alternatively, a user may manually flag or hide certain information on their digital calendar in order to have a de-cluttered view of the information most relevant to the user. Such a process requires tedious user interaction with the user interface, and may be otherwise undesirable as the user may wish to simultaneously have a focused view of particularly important event information while retaining all event information in their overall digital calendar. Presenting calendar event information from event managers onto a user feed, and enabling the user and/or event managers to control how the event information is presented on the user feed, is desirable.

The organization and display of information in a user feed is known and provided by various social networking websites such as Facebook or Twitter. Typically, a user is able to subscribe to or “follow” accounts associated with, for example, friends, family members, businesses, employers, sports teams, etc. The accounts post comments or information that is broadcasted onto the user feed of all of the account's subscribers or followers. However, the feed for any particular user is an undifferentiated mass of information arranged by time of initial posting or prioritized by a system algorithm that is out of the user's control, and frequently includes information that is not particularly relevant at the time it appears in the feed. For example, a Twitter notice of a scheduled event may only appear hours/days/weeks before the event is scheduled to begin.

Accordingly, there is a need for a user interface that is not internally structured on a standard calendar unit basis, does not require persistent local storage of a calendar event object representing the event, and presents calendar event-specific information to a user in a fashion that enables the user and/or event manager to automatically prioritize and control the timing and content of calendar information presented.

### BRIEF SUMMARY

The present embodiments may relate to systems and methods for presenting calendar event information to a user, with additional functionality described herein. The system may include an electronic calendar platform computing device, one or more client devices associated with a user, one or more client devices associated with an event manager, one or more databases, and/or one or more third party servers.

In one aspect, an electronic calendar platform (“ECP”) server, including at least one processor in communication with at least one memory device, is provided. The at least one processor is programmed to receive, from a user application executing on a user computing device, a subscription request identifying an event manager, and in response to the subscription request, create a subscription record in a database. The subscription record associates a user ID of the user with an event manager ID of the event manager. The at least one processor is also programmed to receive, from a manager application executing on an event manager computing device, calendar event information associated with a plurality of events. The calendar event information includes a scheduled date/time for each of the events. The at least one processor is further programmed to create, in the database, a plurality of event records linked to the event manager ID. Each event record of the plurality of event records includes the calendar event information for a corresponding event of the plurality of events. Additionally, the at least one processor is programmed to receive, from the user application, a populate request configured to populate a calendar event feed displayed by the user application on the user computing device. The populate request includes the user ID. In response to the populate request, the at least one processor is programmed to query the database for event records associated with event managers associated with the user ID, generate an ordered sequence of the calendar event information for the events returned by the query, including applying a default rule ordering the returned events in a time sequence according to the scheduled date/time of the events, and transmit the ordered sequence to the user application for display in the calendar event feed. The server may have additional, less, or alternate functionality, including that discussed elsewhere herein.

In another aspect, a computer-implemented method, performed by an electronic calendar platform (“ECP”) server including at least one processor in communication with at least one memory device, is provided. The computer-implemented method includes steps performed by the at least one processor of receiving, from a user application executing on a user computing device, a subscription request identifying an event manager, and in response to the subscription request, creating a subscription record in a database. The subscription record associates a user ID of the user with an event manager ID of the event manager. The steps performed by the at least one processor also include receiving, from a manager application executing on an event manager computing device, calendar event information associated with a plurality of events. The calendar event information includes a scheduled date/time for each of the events. The steps performed by the at least one processor further include creating, in the database, a plurality of event records linked to the event manager ID. Each event record of the plurality of event records includes the calendar event information for a corresponding event of the plurality of events. Additionally, the steps performed by the at least one processor include receiving, from the user application, a populate request configured to populate a calendar event feed displayed by the user application on the user computing device. The populate request includes the user ID. In response to the populate request, the steps performed by the at least one processor include querying the database for event records associated with event managers associated with the user ID, generating an ordered sequence of the calendar event information for the events returned by the query, including applying a default rule ordering the returned events in a time sequence according to the scheduled date/time of the events, and transmitting the ordered sequence to the user application for display in the calendar event feed. The method may have additional, less, or alternate functionality, including that discussed elsewhere herein.

In another aspect, at least one non-transitory computer-readable medium including instructions embodied thereon, is provided. The instructions are executable by at least one processor of an electronic calendar platform (“ECP”) server to cause the at least one processor to receive, from a user application executing on a user computing device, a subscription request identifying an event manager, and in response to the subscription request, create a subscription record in a database. The subscription record associates a user ID of the user with an event manager ID of the event manager. The instructions also cause the at least one processor to receive, from a manager application executing on an event manager computing device, calendar event information associated with a plurality of events. The calendar event information includes a scheduled date/time for each of the events. The instructions further cause the at least one processor to create, in the database, a plurality of event records linked to the event manager ID. Each event record of the plurality of event records includes the calendar event information for a corresponding event of the plurality of events. Additionally, the instructions cause the at least one processor to receive, from the user application, a populate request configured to populate a calendar event feed displayed by the user application on the user computing device. The populate request includes the user ID. In response to the populate request, the instructions also cause the at least one processor to query the database for event records associated with event managers associated with the user ID, generate an ordered sequence of the calendar event information for the events returned by the query, including applying a default rule ordering the returned events in a time sequence according to the scheduled date/time of the events, and transmit the ordered sequence to the user application for display in the calendar event feed. The computer-executable instructions may direct additional, less, or alternate functionality, including that discussed elsewhere herein.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates an example electronic calendar platform computer system for presenting calendar event information to a user.

FIG. 2 illustrates an example configuration of a client computing device that may be used in the electronic calendar platform computer system shown in FIG. 1.

FIG. 3 illustrates an example configuration of a server computing device that may be used in the electronic calendar platform computer system shown in FIG. 1.

FIG. 4 illustrates a flow diagram of an example computer-implemented method that may be implemented by the electronic calendar platform computer system shown in FIG. 1.

FIG. 5 illustrates an example user interface of an electronic calendar application that may be executed by the client device shown in FIG. 2.

FIG. 6 illustrates an example data structure that may be implemented by the server computing device shown in FIG. 3 to enable the electronic calendar platform computer system shown in FIG. 1.

FIG. 7 illustrates an example system for synchronizing multiple calendars to schedule one or more events using the electronic calendar platform computer system shown in FIG. 1.

FIG. 8 illustrates an exemplary process for synchronizing multiple calendars to schedule one or more events using the system shown in FIG. 7.

FIGS. 9A and 9B illustrate screenshots of an exemplary calendar for the electronic calendar platform computer system shown in FIG. 1.

FIG. 10 illustrates a screenshot of an exemplary event list for a specific day for the electronic calendar platform computer system shown in FIG. 1.

FIG. 11 illustrates a screenshot of a list of event managers to be followed on the electronic calendar platform computer system shown in FIG. 1.

FIG. 12 illustrate a screenshot of a near and noteworthy feature of the electronic calendar platform computer system shown in FIG. 1.

FIGS. 13A and 13B illustrate screenshots 1300 and 1310 of a calendar sync feature of the electronic calendar platform computer system shown in FIG. 1.

The Figures depict preferred embodiments for purposes of illustration only. One skilled in the art will readily recognize from the following discussion that alternative embodiments of the systems and methods illustrated herein may be employed without departing from the principles of the disclosure described herein.

### DETAILED DESCRIPTION

The present embodiments relate to, inter alia, systems and methods for presenting calendar event information (also referred to herein as “calendar events”, “event information” or “information”) to a user from event manager accounts (also referred to herein as “event managers”, “managers” or “accounts”). In some embodiments, the process may be implemented by an electronic calendar platform (“ECP”) computer system (also referred to herein as an “ECP platform” or an “ECP server”). The system interfaces with a client-side application that enables a user to follow accounts of event managers and to view calendar event information input by event manager accounts that the user is following on a calendar event feed. For example, the calendar event feed is populated with and displays a sequence of calendar event information from event manager accounts that a user is following. For example, the calendar event feed may include information related to the date, time, and/or location of a scheduled event, a description of the scheduled event (e.g., topic, attire, directions, a list of participants, a list of organizers), and/or any other supplemental information and/or content associated with a scheduled event. Supplemental information and/or content provided with calendar event information may include, for example, hyperlinks to online retailer websites to enable a user to quickly purchase items suitable for specific events. The hyperlink may be presented to the user in the feed along with the calendar event information. The calendar event feed may also include posts from event managers about newly scheduled events, changes in scheduled events, or canceled events.

A user may be an individual or a group of individuals. The user may be interested in receiving calendar event information associated with scheduled events in which the user plans to participate or otherwise engage. The user may also be interested in receiving calendar event information associated with a scheduled event in which an individual other than the user plans to participate or otherwise engage. For example, the user may be a parent that is interested in tracking calendar event information associated with a scheduled event in which a child plans to participate or otherwise engage.

An event manager may be an individual, a group of individuals, an organization, and/or any other entity that plans, organizes and/or hosts one or more scheduled events. An event manager may include, for example, a school, a teacher, a business, a club, a vendor of goods, a vendor of services, a sports team, a coach, a professional service provider, and the like.

In some embodiments, an electronic calendar platform (e.g., provided by an electronic calendar platform server) may connect a user to one or more event managers that are associated with scheduled events in which the user is interested in participating, engaging, or otherwise tracking. The electronic calendar platform may present calendar event information (e.g., a date, time, and/or location) associated with scheduled events of the event managers that the user is subscribed to, according to user and event manager preferences. In certain embodiments, one or more users and one or more event managers may register for the electronic calendar platform (“ECP”) provided by an ECP server through a client application (e.g., an ECP application) on a mobile device associated with the respective user and event manager, or any other suitable device that may access the ECP application and/or a website associated with the ECP application. In some embodiments the client application may include a user application for subscribing to, and displaying the feed of events from, event managers, and a separate manager application for event managers to configure calendar events. Alternatively, the functionality of both the user application and the manager application are implemented in a single client application (i.e., the client application provides full functionality for someone who is both an event manager and subscribes as a user to other event managers). It should be understood that references separately to the “user application” and the “manager application” also encompass embodiments in which the functionality of both are included in a single client ECP application, and references to the “ECP application” in the context of user or manager functionality also encompass separate implementations of the user application and the manager application, unless otherwise specified.

In some embodiments, a user that is registered through the ECP application is able to subscribe to or follow event managers that are also registered through the ECP application. A registered event manager may input calendar event information (e.g., date, time, and/or location information) into the ECP application and the calendar event information may be stored by the ECP server. In response to a user “following” or subscribing to an event manager, the calendar event information input by the event manager may be provided or otherwise become available to the user via the ECP application. For example, the ECP server may generate a calendar event feed that is displayed on a user's device through the ECP application. The calendar event feed may be populated with calendar event information of event managers that the user is following. The calendar event feed may be continuously updated by the ECP server as event managers input calendar event information related to, for example, changes in and/or newly scheduled events.

In the example embodiment, the calendar event feed is populated by the ECP server in response to the user's computing device activating or logging in to the ECP application, independently of any calendar event data stored persistently by the user device. This is advantageous because, in other words, no calendar event objects corresponding to the calendar events are required to be stored by the user device, which advantageously conserves digital storage resources for each user, avoids the need to review and update previously stored calendar event data on the user's device, and avoids redundant digital storage of the same calendar event on the devices of multiple users associated with the event. These advantages improve the operation of the calendar system and reduce the processing, memory, and bandwidth resources required to operate the system. In some embodiments, the ECP application also may be in communication with a conventional calendar application installed on the user's device, and the user may selectively choose to upload calendar event information from the feed into a calendar event object for use by the user's conventional calendar application; however, the calendar feed provided by the ECP application is independent of the locally stored calendar event objects.

In certain embodiments, the ECP server implements a data structure that facilitates rapid population/refresh of the user's feed of all events for all event managers which a user is following. Each user is assigned a unique user identifier (UserID), and each event manager is assigned a unique event manager identifier (EventMgrID). In some embodiments, the data structure includes a subscription table with records corresponding to each subscription of any user to any event manager. For example, the table includes a UserID field, an EventMgrID field, and a UserPreference field to store specific user preferences (as discussed below) with respect to the associated event manager.

In some embodiments, the data structure enables rapid refresh with respect to a particular user, in response to a request from the ECP application of a user to populate the user's feed (e.g., triggered by user activation of the ECP application or log-in to the ECP application), and also rapid refresh with respect to all users following a particular event manager in response to a “push” request input by an event manager. For example, the subscription table is indexed on both the UserID field (for rapid population/refresh of the user feed corresponding to a specific UserID) and the EventMgrID field (for rapid notifications via the user feed, or via another channel, to all users following the corresponding event manager).

In some embodiments, an event manager may classify or categorize the calendar event information input by the event manager and transmitted to the user feed by assigning one or more labels to the calendar event information stored by the ECP server. The label(s) assigned to the calendar event information may indicate a type of event that the calendar event information is associated with, and/or an urgency of the information. The label(s) may be assigned to the calendar event information based on input provided by the event manager when inputting the calendar event information. For example, if the event manager is a coach of a sports team, a “game” or “practice” label or tag may be provided along with other calendar event information (e.g., a time, date, and/or location) input by the coach. The ECP server may then assign a “game” or “practice” label accordingly, which enables the user to distinguish the calendar event information from other information displayed in the calendar event feed that is posted by the same event manager but has a different label. The ECP server may also enable users to filter or group calendar event information that is broadcasted on the calendar event feed based on the assigned label(s). For example, users (e.g., players or parents of players) that follow a coach may apply a filter so that only calendar event information that has a “game” label is displayed on their calendar event feed, or that calendar event information that has a “game” label is displayed at a higher priority than events having a “practice” label. In some embodiments, the label information and corresponding preferences are stored in the Preferences field of the subscription table and associated with the subscription record, to facilitate rapid identification and application of the user's preferences when the user feed is populated. The label(s) assigned by the ECP server therefore enable a user to specifically tailor the event information displayed on the calendar event feed, on a per-event manager basis, to the user's immediate priorities or interests.

The ECP server may also enable a user to selectively adjust when calendar event information is displayed on the calendar event feed. Calendar event information may be input via the ECP application at a time that is convenient for an event manager, however, some users may not be interested in having all event information immediately displayed in their ECP application feed upon entry into the system. For example, if an event manager inputs calendar event information that is associated with an event that is scheduled to begin at a later time/date (e.g., two weeks later), the user may wish to have the calendar event information displayed on the ECP application feed at a time closer to the scheduled time/date. The user may input preference information, which is stored by the ECP server (for example, in the Preferences field of the subscription table), so that calendar event information is displayed in the user feed only when the event is scheduled to begin within a certain amount of time/number of days. The user may also adjust when calendar event information is displayed in the calendar event feed based on the label(s) assigned to the calendar event information. For example, if the user is particularly interested in, or would like early notification of, calendar event information assigned a certain label, the user may input preference information so that calendar event information assigned that label is displayed in the user feed immediately upon submission of the calendar event information by the event manager.

In addition, the ECP server may enable an event manager to selectively adjust when calendar event information is displayed in the calendar event feed of users following the event manager. For example, the event manager may provide with the calendar event information a label that indicates the calendar event information is urgent and should be immediately displayed in the user feeds of followers of the event manager. In some embodiments, the ECP server may enable an event manager to circumvent user preference information that would otherwise delay the display of the calendar event information on a follower's user feed by using a “push” notification in order to have the calendar event information immediately displayed.

The ECP server may also enable an event manager to selectively adjust which followers of the of the event manager receive certain calendar event information in their calendar event feeds. An event manager may input calendar event information associated with a scheduled event that is relevant only to a select number of followers of the event manager. For example, if the event is a stage production in a theater, the event manager may calendar a first set of events (e.g., script read-throughs) that apply only to the actors, a second set of events (e.g., stage design/construction) that apply only to the stage crew, a third set of events (e.g., dress rehearsals) that apply to both actors and stage crew, and a fourth set of events (e.g., ticket on-sale dates, production dates) that also apply to interested patrons of the theater. The event manager may therefore not wish that the calendar event information for all types of events be broadcasted to the calendar event feeds of all followers of the stage production event. The ECP application may enable the event manager to assign followers to subgroups, and then designate, for each set of calendar event information, one or more of the subgroups of followers that should receive the information. Additionally or alternatively, the ECP application may enable the event manager to “tag” specific users with labels for a given event, and only tagged users receive the calendar information associated with the event.

In the exemplary embodiment, the ECP server may also generate reminder notifications for a user. The ECP server may send the reminder notifications to the user's mobile device through the ECP application using notification services such as push notifications, for example. The ECP server may automatically generate reminder notifications for upcoming scheduled events determined by the calendar event information of event managers that the user is following. For example, the ECP server determines that a scheduled event is occurring that day and generates and sends a reminder notification of the scheduled event. The user may also input preference information to adjust the timing of reminder notifications and/or to disable reminder notifications associated with certain calendar event information, on a per-event manager basis or per-event basis. For example, the user may adjust the timing of, and/or disable, reminder notifications for calendar event information that is assigned a certain label, as described herein.

In the exemplary embodiment, the ECP server may receive location data of the user and generate reminder notifications based on the location data. The ECP server may receive location data through the ECP application that may be in communication with a location module, such as a global positioning satellite (GPS) module, that is installed on a user's mobile device. The ECP server may determine that a user is within a certain proximity to a location associated with a scheduled event and notify the user of the scheduled event. For example, the user may follow a dry cleaner event manager that inputs calendar events corresponding to a scheduled clothes pick-up, and a label corresponding to a pick-up location. The ECP server may send a reminder notification to the user when the user is within a certain proximity (e.g., within a mile) of the pick-up location. The ECP server may also receive an indication from the user that the scheduled event has been completed and disable generating location-based reminder notifications until a new scheduled event is input by an event manager.

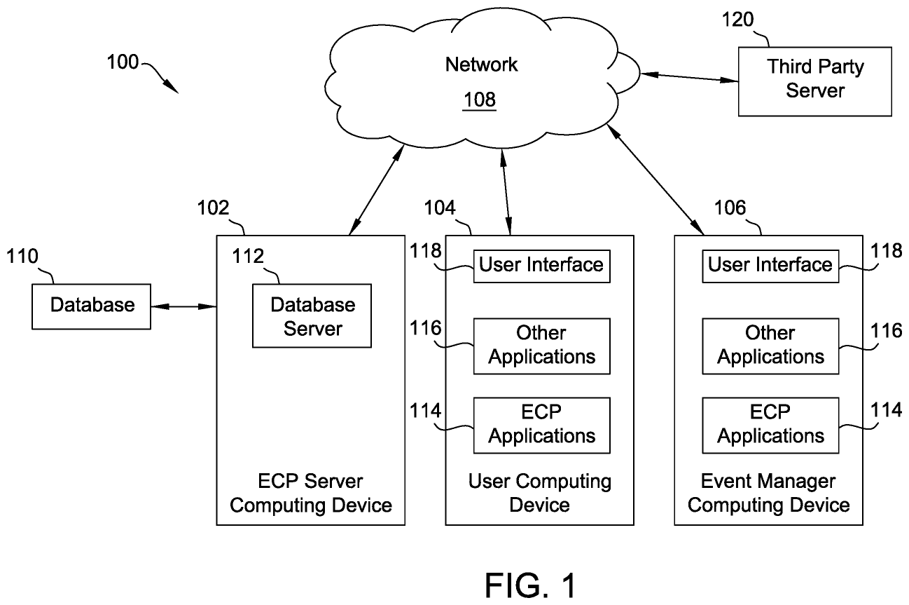

FIG. 1 is a schematic diagram illustrating an exemplary electronic calendar platform (“ECP”) system 100 for presenting calendar event information to a user. In the exemplary embodiment, ECP system 100 includes an ECP server computing device 102, a user computing device 104, an event manager computing device 106, and a third party server 120. ECP server 102, user computing device 104, event manager computing device 106, and third party server 120 are in communication over a network 108. ECP server 102 is also in communication with a database 110 and may communicate with database 110 through a database server 112. Database server 112 may be a component of ECP server 102, or database server 112 may be separate from ECP server 102. In some embodiments, ECP system 100 may include a plurality of ECP servers 102, user computing devices 104, event manager computing devices 106, databases 110, and/or third party servers 120.

Network 108 may be implemented as a single network or a combination of multiple networks. For example, network 108 may include the Internet and/or one or more intranets, landline networks, wireless networks, and/or other appropriate types of communication networks. Additionally or alternatively, network 108 may comprise a wireless telecommunications network (e.g., cellular phone network) adapted to communicate with other communication networks, such as the Internet.

User computing device 104 and event manager computing device 106 may be computers that include a client application, such as a web browser or a dedicated software application, which enables computing devices 104 and 106 to access remote computer devices, such as ECP server 102, via network 108. Computing devices 104 and 106 may be any device or combination of hardware and/or software capable of wired and/or wireless communication over network 108. Examples of computing devices 104 and 106 include, but are not limited to including, a desktop computer, a laptop computer, a personal digital assistant (PDA), a cellular phone, a smartphone, a tablet, a smart home device, a phablet, wearable electronics such as a smart watch, or other web-based connectable equipment or mobile devices. While the above-described non-limiting examples apply to both computing devices 104 and 106, in many cases, user computing device 104 may be different from event manager computing device 106. In other cases, computing devices 104 and 106 may be the same computing device, i.e., an individual using the device may be both an event manager and a user following other event managers.

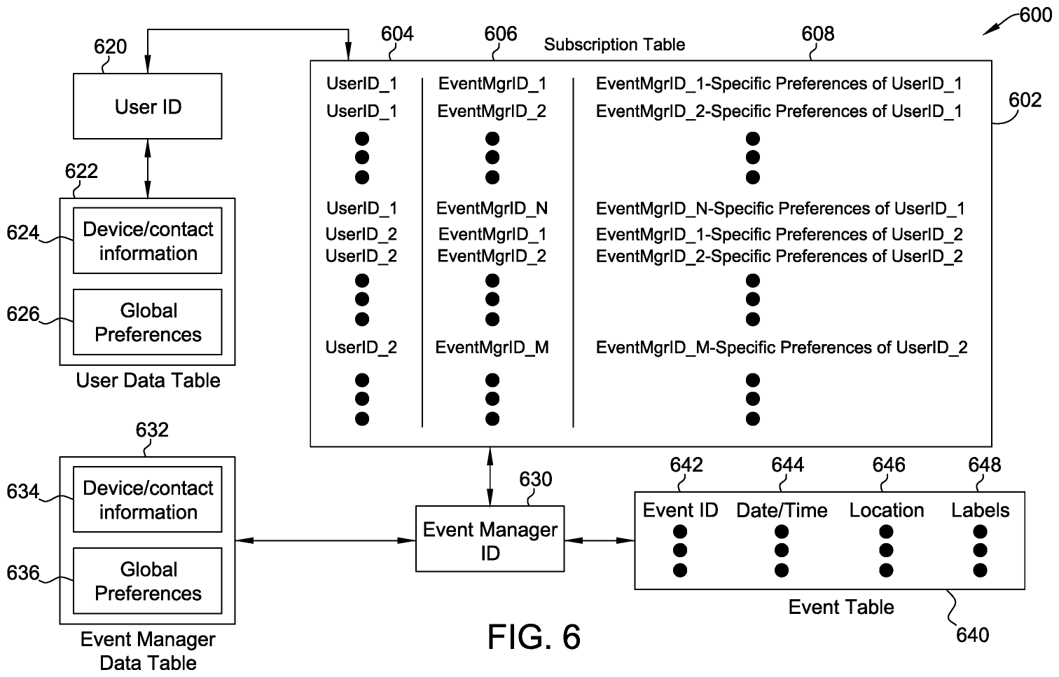

ECP server 102 may receive a user registration request from user computing device 104. In response to the user registration request, the ECP server 102 may register the user and create a user account on an ECP platform. The user registration request may include user data of the user. The user data may include personal data (e.g., name, e-mail address, phone number) and user interests and hobbies. The user data may also include scheduled user tasks (e.g., getting groceries, car maintenance, home maintenance, picking up dry cleaning, etc.), scheduled user activities (e.g., social activities, like parties and weddings, and physical activities, like workout classes etc.), scheduled user appointments (e.g., recurring appointments like yearly physicals and bimonthly haircuts, etc.), and any other information associated with the user that may be useful to ECP server 102. ECP server 102 may create and/or store the user account associated with the user in database 110 based on the user data received with the user registration request. For example, with reference also to FIG. 6, database 110 may implement a data structure 600. ECP server 102 may assign a unique UserID 620 to each registered user, and may store the user data in a User Table 622 indexed by the UserID field. User Table 622 may store, for example, device/contact information 624 associated with the user computing device 104 (e.g., a device identifier, phone number, email address, or other information suitable for establishing one or more communication channels with the user), global preferences 626, and/or any other suitable user data.

ECP server 102 may also receive an event manager registration request from event manager computing device 106. In response to the event manager registration request, the ECP computing device 102 may register the event manager and create an event manager account on the ECP platform. The event manager registration request may include event manager data of the event manager. The event manager data may include information that identifies the event manager (e.g., name, contact information, etc.) and information that indicates a purpose of the account (e.g., whether the account is a school, business, club, sports team, etc.). The event manager data may include any other information associated with the event manager that may be useful to ECP computing device 102. ECP computing device 102 may create and/or store an event manager account associated with the event manager in database 110 based on the event manager data received with the event manager registration request. For example, with reference also to FIG. 6, data structure 600 may include an Event Manager Table 632. ECP server 102 may assign a unique EventMgrID 630 to each registered user, and may store the event manager data in Event Manager Table 632 indexed by the EventMgrID field. Event Manager Table 632 may store, for example, device/contact information 634 associated with the event manager computing device 106 (e.g., a device identifier, phone number, email address, or other information suitable for establishing one or more communication channels with the event manager), global preferences 636, and/or any other suitable user data.

ECP server 102 may receive registration requests from respective user computing devices 104 and event manager computing devices 106 over network 108. For example, a user and an event manager may download an ECP application 114 to user computing device 104 and event manager computing device 106, respectively, and input data into ECP application 114 for registration with the electronic calendar platform provided by ECP computing device 102. The use of the term “ECP application” also envisions embodiments in which certain users and event managers may access the described functionality via a website hosted by ECP server 102 using a web browser. For example, users and event managers may input registration data into the website to register with ECP system 100.

ECP server 102 may also receive event data from event manager computing device 106, for example on one or more occasions after the corresponding event manager has registered with ECP system 100. The event data may include calendar event information of scheduled events planned, organized and/or hosted by the event manager. Calendar event information may include, for example, a date, time, and/or location of a scheduled event, a description of the scheduled event (e.g., topic, attire, directions, a list of participants, a list of organizers), and/or any other supplemental information and/or content associated with a scheduled event. For example, with reference also to FIG. 6, data structure 600 may include an Event Table 640 linked to each EventMgrID 630. ECP server 102 may assign a unique EventID 642 to each calendar event input by event manager computing device 106, and may store the event data in the event manager's Event Table 640 indexed by the EventID field. Event Table 640 may store, for example, the event scheduled date/time 644, the event location 646, and/or any other suitable user data. In other embodiments, rather than having a separate Event Table 640 for each EventMgrID 630, a global Event Table may store the same data for a plurality of event managers, indexed by EventMgrID to link the event managers to their corresponding events. In some embodiments, the event data base also include the group and/or subgroup that the event is for.

ECP computing device 102 may also receive from user computing device 104 (e.g., via ECP application 114) a subscription request to subscribe to or “follow” an event manager account associated with an event manager registered on the ECP platform. Users may browse for event manager accounts using ECP application 114 and access profile pages (discussed further below) associated with the event manager accounts. ECP server 102 may cause a prompt to be displayed on an event manager profile page accessed by a user that allows the user to select to follow the event manager account. ECP server 102 may also generate recommendations of event manager accounts that the user may be interested in following based on user data and event manager data stored in database 110 and/or on other event manager accounts the user follows. ECP server 102 may cause these recommendations to be displayed to the user with a prompt that allows the user to select to either follow a recommended account or to ignore the recommendation. When a user selects to follow an event manager account, ECP computing device 102 may automatically subscribe the user to the event manager account and store this information in database 110. In some further embodiments, the user data for the subscription may also include the group and/or subgroup that the user is in or desired to be in.

For example, with reference also to FIG. 6, data structure 600 may include a Subscription Table 602 that includes a UserID field 604 and an EventMgrID field 606. ECP server 102 may create a subscription record linking the UserID 620 of the user to the EventMgrID 630 of the followed event manager, and may store the subscription record in Subscription Table 602. Accordingly, Subscription Table 602 includes a subscription record corresponding to each “follow” of an event manager by a user. In some embodiments, data structure 600 enables rapid refresh of the calendar feed of a particular user, in response to a request from ECP application 114 to populate the user feed, and also for rapid notifications of event updates via the user feed, or via another channel, to users following the corresponding event manager in response to a “push” request input to ECP application 114 by an event manager for a particular event update. For example, an event manager that is a merchant may choose to send a push for a new event corresponding to a “flash” sale, an event manager that is a coach may choose to send a push for a last-minute time change for a game, any event manager may choose to send a push to note the cancellation of a previously calendared event, etc.

In some embodiments, Subscription Table 602 is indexed on both UserID field 604 (for rapid population/refresh of the user feed corresponding to a specific UserID) and EventMgrID field 606 (for rapid population/refresh of the user feed of all users following the corresponding event manager).

More specifically, in response to the user functionality (e.g., the event feed) of ECP application 114 being activated or refreshed, ECP application 114 transmits a “populate” request, including information representative of the corresponding UserID 620, to ECP server 102. ECP server 102 queries Subscription Table 602 for all subscription records that include the corresponding UserID 620, and the query returns all EventMgrIDs 630 followed by the user. In turn, ECP server 102 queries the respective Event Table 640 linked to each returned EventMgrID 630, and the query returns all calendar events eligible to appear in the user's feed. ECP server 102 may further apply user and event manager preferences, as discussed further below, to filter the returned calendar events provided to ECP application 114 for display in the user's feed. Accordingly, data structure 600 enables rapid population/refresh of the user's calendar feed. Notably, and in contrast to conventional calendar applications, the calendar feed is advantageous because it is independent of any persistent storage of the event data on each user computing device 104, which advantageously reduces redundant storage and updating of the same data on multiple local computers and reduces digital storage resources required by the local computer, particularly when the user subscribes to event managers having a large number of events. This advantageously reduces the processing, memory, and/or bandwidth resources required to use the calendar feed application.

Likewise, in response to input from the event manager “push” functionality of ECP application 114, ECP application 114 transmits information representative of the corresponding EventMgrID 630 to ECP server 102. ECP server 102 queries Subscription Table 602 for all subscription records that include the EventMgrID 630, and the query returns all UserIDs 620 following the event manager. In turn, ECP server 102 queries the User Table 622 for each returned UserID 620, and the query returns device/contact info 624 needed to apprise each user of the new input by the event manager. ECP server 102 may further apply user and event manager preferences specific to push requests from the event manager (e.g., for new events or event changes deemed worthy of an alert), as discussed further below, to determine whether and how to contact each user (e.g., push notification to the respective user computing device 104, activation/refresh of ECP application 114 on the respective user computing device 104 with the change input by the event manager at the top of the user feed, text message or robo-call, etc.). Accordingly, in response to a “push” request from an event manager, data structure 600 enables rapid notification to all users following the event manager.

In alternative embodiments, data structure 600 has any suitable architecture and/or indexing scheme that enables ECP system 100 to function as described herein.

In some embodiments, event managers have the option of accepting or declining subscription requests by users. For example, in response to a request to subscribe to or “follow” an event manager account from user computing device 104 (e.g., via ECP application 114), ECP server 102 may transmit a follow request to event manager computing device 106 indicating that the user has selected to follow the event manager account. ECP application 114 on event manager computing device 106 causes the follow request to be displayed to the event manager with a prompt that allows the event manager to select to accept or deny the follow request. ECP server 102 does not subscribe the user to the event manager account (e.g., does not create a subscription record for the user-event manager pair in Subscription Table 602) until the event manager has selected to accept the follow request. Event managers may also input privacy preference information via ECP application 114 (e.g., as part of global preferences 636) that proactively restricts the users that are able to follow the event manager to a select subset of users. For example, each of the users in the subset may be expressly identified by the event manager (e.g., by an email address or phone number that can be directly matched to the user's data in User Data Table 622), or the subset may be defined by filter criteria which are applied automatically by ECP server 102 to subscription requests. Furthermore, event managers may assign followers to different groups and/or subgroups to determine the notifications and events that those followers will receive.

ECP server 102 may also receive (e.g., via ECP application 114) other data from the users and event managers for storage in data structure 600. For example, the user may input preferences into ECP application 114 related to the presentment of calendar event information to the user (e.g., preferences of when the user would like events to appear in the user's feed relative to a date/time of an upcoming event; preferences for what type of events merit an alert notification outside the user's feed and how the user would like to be notified, such as receiving an SMS text notification to the mobile phone number of user computing device 104 and/or a push notification from ECP application 114; etc.). For example, with reference also to FIG. 6, the user may input global preferences (e.g., reminder timing, notification channel) applicable to all followed event managers, and ECP server 102 may store the user's global preferences in the Global Preferences field 626 of the user's record in User Table 622. Additionally, the user may input preferences specific to a particular event manager, and ECP server 102 may store the event manager-specific preferences in an Event Manager-Specific Preferences field 608 of the subscription record in Subscription Table 602.

For another example, the event manager may input preferences into ECP application 114 related to the presentment of calendar event information to all subscribing users (e.g., preferences of when the event manager would like events to appear in the users' feeds relative to a date/time of an upcoming event; preferences for what type of events, if any, merit an alert notification outside the users' feed and how the alert would be provided, such as via an SMS text notification to the mobile phone number of user computing device 104 and/or a push notification from the user's ECP application 114; etc.). For example, with reference also to FIG. 6, the event manager may input global preferences (e.g., reminder timing, notification channel) applicable to all subscribing users, and ECP server 102 may store the event manager's global preferences in the Global Preferences field 636 of the event manager's record in Event Manager Table 632.

In some embodiments, an event manager may classify or categorize a specific calendar event by inputting one or more labels via ECP application 114 for association with the calendar event. For example, ECP server 102 may store one or more event-specific labels in a Labels field 648 of the event record in the event manager's Event Table 640. The label(s) assigned to the calendar event may indicate a type of the event and/or a relative urgency of the information. For example, if the event manager is a coach of a sports team, a “game” or “practice” label or tag may be entered via the event manager's ECP application 114 along with other calendar event information (e.g., a time, date, and/or location) input by the coach. ECP server 102 may then assign a “game” or “practice” label accordingly, e.g., by storing corresponding information in Labels field 648 of the event record. In turn, each user following the event manager may enter label-specific preferences through the respective user's ECP application 114, and ECP server 102 may store that information in the Event Manager-Specific Preferences field 608 of the subscription record for the respective user-event manager pair in Subscription Table 602, which facilitates rapid identification and application of the user's preferences when the user feed is populated. This enables each user to define individual feed timing and notification preferences for events posted by the same event manager that have different labels. For example, users (e.g., players or parents of players) that follow a coach may store a preference in field 608 that causes calendar events that have a “game” label to generate a push notification at a selected number of hours before game time (in addition to appearing in the user's feed), whereas events having a “practice” label only appear in the user's feed.

Additionally or alternatively, ECP application 114 on user computing device 104 may provide client-side filtering capabilities. For example, users (e.g., players or parents of players) that follow a coach, and are in the process of planning other family events that need to avoid conflicts with game times, may apply a filter at ECP application 114 so that the user's feed shows only calendar events that have a “game” label, whereas events having a “practice” label are excluded or moved to the bottom of the feed.

The label(s) defined by the event manager therefore enable each user to specifically tailor the event information displayed on the user's calendar event feed, using one or both of stored preferences in data structure 600 or filtering capabilities of ECP application 114, to suit the user's immediate priorities or interests at a given time.

The sequence of calendar event information provided by ECP server 102 to populate each user's feed may be determined based on a preselected hierarchy of user and event manager preferences stored in data structure 600. In some embodiments, as discussed above, when the user's ECP application 114 sends a populate request, ECP server 102 queries Subscription Table 602 for all subscription records that include the corresponding UserID 620, and the query returns all EventMgrIDs 630 followed by the user. In turn, ECP server 102 queries the Event Table 640 linked to each returned EventMgrID 630, and the query returns all calendar events eligible to appear in the user's feed. In certain embodiments, the lowest level in the hierarchy is system default feed rules. In other words, in the absence of any contrary preferences as to display sequencing indicated in Global Preferences 626 of the user, Global Preferences 636 of the event manager, or Event Manager-Specific Preferences field 608 of the subscription record, ECP server 102 applies the default feed rules. For example, using the default feed rules, ECP server 102 transmits data corresponding to the calendar events returned by the query to the user's ECP application 114 in a sequence ordered according to the date/time information for each of the events (e.g., the value stored for each event in date/time field 644), starting with the present date/time and ending at a default later time (e.g., two months in the future) or after a default number of calendar events (e.g., fifty events) after the starting date/time is reached.

In certain embodiments, ECP application 114 enables the user to request a different time window for the feed, such that the ECP server 102 transmits, e.g., past events or only events scheduled on or after a selected future date/time, sequenced according to the hierarchy of preferences, for populating the user's feed.

In some embodiments, display preferences defined by the event manager are the next level of the hierarchy above default feed rules. In other words, any display preferences defined by the event manager (e.g., by data stored in Global Preferences 636), in the absence of any contrary preferences as to display timing selected by the individual user either globally (e.g., as indicated in Global Preferences 626 of the user) or with respect to the specific event manager (e.g., as indicated in Event Manager-Specific Preferences field 608 of the subscription record), is applied to override the default feed rules in the event of a conflict between the two. For example, the event manager may establish a preference that events labeled “game” appear at the top of the user's feed for three days in advance of the actual game date/time (e.g., three days in advance of the date/time stored in date/time field 644) to ensure no players are caught unaware by the game. In response to any populate request occurring later than three days in advance of the actual event date/time, ECP server 102 moves the game event to the first position in the ordered sequence of calendar event information provided to ECP application 114 to populate the user's feed. As another example, the event manager may establish a preference that events labeled “game” generate a separate reminder event in the user's feed 72 hours in advance of the actual game date/time. In other words, rather than maintaining the game event in the first position in the ordered sequence of calendar event information provided to ECP application 114, ECP server 102 inserts a “reminder” for the event into the ordered sequence of events at a date/time 72 hours in advance of the actual event date/time, as well as maintaining the game event at its actual date/time lower down in the feed. The surrounding sequencing of other events established by the event manager, and of events established by other event managers “followed” by the user, remains unaffected.

In some embodiments, global display preferences defined by the user are the next level of the hierarchy above the event manager's preferences. In other words, any display preferences defined by the individual user (e.g., by data stored in Global Preferences 626), in the absence of any contrary preferences as to display timing selected by the individual user with respect to the specific event manager (e.g., as indicated in Event Manager-Specific Preferences field 608 of the subscription record), is applied to override the default feed rules and the preferences of the event manager (e.g., by data stored in Global Preferences 636) in the event of a conflict. For example, the user may establish a global preference that all events appearing in the user's feed generate a separate reminder event in the user's feed 48 hours in advance of the actual event date/time. ECP server 102 inserts a “reminder” for each event into the ordered sequence of events at a date/time 48 hours in advance of the actual event date/time, as well as maintaining the event at its actual date/time lower down in the feed. For another example, the preference information may indicate a limited time window (e.g., a day before through the day of, solely the day of, solely an hour before, etc.) relative to the date/time of a scheduled event during which the user prefers to have the calendar event displayed on the user's feed.

In some embodiments, display preferences defined by the user with respect to the particular event manager are the highest level of the hierarchy. In other words, any display preferences defined by the individual user with respect to the specific event manager (e.g., as indicated in Event Manager-Specific Preferences field 608 of the subscription record) override the user own global preferences (e.g., as indicated in Global Preferences 626 of the user), the preferences of the event manager (e.g., as indicated in Global Preferences 636), and the default feed rules in the event of a conflict. For example, for the event manager that is a coach of a youth team, the user may establish a preference that events labeled “game” appear at the top of the user's feed for two days in advance of the actual game date/time (e.g., two days in advance of the date/time stored in date/time field 644) to ensure that the user is not caught unaware by the game. In response to any populate request occurring later than two days in advance of the actual event date/time, ECP server 102 moves the game event to the first position in the ordered sequence of calendar event information provided to ECP application 114 to populate the user's feed. As another example, the user may establish a preference that events labeled “game” generate a separate reminder event in the user's feed 48 hours in advance of the actual game date/time. In other words, rather than maintaining the game event in the first position in the ordered sequence of calendar event information provided to ECP application 114, ECP server 102 inserts a “reminder” for the event into the ordered sequence of events at a date/time 48 hours in advance of the actual event date/time, as well as maintaining the game event at its actual date/time lower down in the feed. The surrounding sequencing of other events established by the event manager but not labeled “game,” and of events established by other event managers “followed” by the user, remains unaffected.

The “push” notification capability described above may be subject to different preference settings of users and event managers from the preferences that affect user feeds. For example, the user's global preferences (e.g., stored in the Global Preferences field 626 of the user's record in User Table 622) may define one or more preferred channels of the user to receive “push” notifications. For example, the user's preferences may include one or more of a push notification to the user's user computing device 104 (i.e., a message window popped up on the user's user computing device 104); an automatic full activation/refresh of ECP application 114 on the respective user computing device 104 with the pushed event at the top of the user feed; and/or an SMS text message or robo-call to the user's user computing device (e.g., using a phone number stored in device/contact information 624 of the user's record in User Table 622). The event manager may also store “push” notification preferences (e.g., stored in the Global Preferences field 636 of the event manager's record in Event Manager Data Table 632) for use in an absence of user preferences, and ECP server 102 may store default push notification rules for use in an absence of both user and event manager preferences. The push notifications may include changes to events as well. For example, if the field that a soccer match is on changes.

In other embodiments, any suitable display hierarchy for feed preferences and/or push notification preferences is used.

As discussed above with respect to the theater production example, ECP application 114 may enable the event manager to assign followers to subgroups, and then designate, for each set of calendar event information, one or more of the subgroups of followers that should receive the information. In some embodiments, ECP server 102 tracks the subgroups by creating a unique EventMgrID 630 for each subgroup created by the event manager, and using the EventMgrID 630 corresponding to the applicable subgroup in the EventMgrID field 606 of the subscription records for members of that subgroup. A separate Event Table 640 linked to each unique EventMgrID 630 then stores only events relevant to the corresponding subgroup. Accordingly, when users in a subgroup request to populate their feeds, the query of Subscription Table 602 by ECP server 102 returns the unique EventMgrID corresponding to the subgroup, resulting in calendar events from the Event Table 640 corresponding to the subgroup being identified for the users' feeds. Additionally or alternatively, ECP application 114 may enable the event manager to “tag” specific users with labels (e.g., labels having a “tag” prefix and identifying the user account, stored in Labels field 648 in the event record in Event Table 640) for a given event. When ECP server 102 retrieves the event in a query, it discovers the “tags” in Labels field 648 and only provides the calendar information associated with the event to the users identified by the tags. Furthermore, the users may be assigned to the subgroups and/or approved for the subgroups by the event manager.

Users and event managers may update the user and event manager data stored in data structure 600 at any time through ECP application 114. For example, event managers may input updated calendar event information. Updated calendar event information may include information associated with newly scheduled events, changes to scheduled events, and/or canceled events of the event manager.

ECP application 114 may be in communication with other applications 116 of user computing device 104 and event manager computing device 106. ECP application 114 may import user and event manager data from other applications 116. For example, event managers may allow ECP application 114 to retrieve data from a conventional calendar application 116 on event manager computing device 106 to define new calendar events for storage in data structure 600. ECP application 114 may also export data to other applications 116. For example, ECP application 114 on user computing device 104 may export calendar event information received in the user feed in ECP application 114 to calendar application 116 to seamlessly integrate and sync ECP application 114 with conventional digital calendars.

User computing device 104 and event manager computing device 106 also include a user interface 118. User interface 118 may be used, for example, to input information into ECP application 114 and/or to display content from ECP application 114.

ECP server 102 may create profile pages associated with user accounts and event manager accounts for viewing on user computing devices 104 and event manager computing devices 106. The profile pages may be accessed by other users and event managers that are registered on the ECP platform and displayed by ECP application 114 on user interface 118 of respective user computing devices 104 and event manager computing devices 106. The profile pages may display a brief profile of the user or event manager associated with the account that is generated by ECP server 102 using data received from the user or event manager and stored in database 110. For example, the profile pages may display information that identifies the user or event manager associated with the account. Users and event managers may upload, to ECP server 102 (e.g., through ECP application 114), photos or other media content to be displayed on the profile page associated with their account. The profile pages may also display calendar event information of scheduled events associated with the user or event manager. A user or event manager may input privacy preference information in ECP application 114 that restricts content displayed on the profile page associated with their account when accessed by other users or event managers.

ECP server 102 may also receive (e.g., through ECP application 114) a request from the event manager to send an invite to a user or users registered on ECP system 100 for the user(s) to follow the event manager account. Event managers may input information that identifies a particular user account, or a group of user accounts, along with a user invite request that causes ECP server 102 to generate an invite to send to the user account(s). ECP server 102 may cause the invite to be displayed (e.g., through ECP application 114) to user(s) associated with the user account(s) identified by event manager. The invite may include a prompt that allows the user(s) to select to accept or deny the invite to follow the event manager account. If the user(s) accepts the invite, ECP server 102 may subscribe the user(s) to the event manager account and store this information in database 110 (e.g., by creating a new subscription record in Subscription Table 602).

In some embodiments, ECP application 114 may also monitor location data from a location module, such as a global positioning satellite (GPS) module, that is installed on user computing device 104, and if enabled by the user's preferences, transmit the location data to ECP server 102, e.g., in the populate request. ECP server 102 may compare the location data to location-based labels (e.g., stored in Labels field 648) and insert events into the user's feed and/or send pushes to user computing device 104 based on the comparison. For example, ECP server 102 may determine that a user is within a certain proximity to a location associated with a scheduled event and push a reminder to the user of the scheduled event. For example, the event manager may be a Dry Cleaner and the event may be for the user to pick-up clothes before an end date set by the event manager. ECP server 102 may move the event to the top of the user's feed and/or send a push notification when the user is within a certain proximity to the location of the scheduled pick-up event (e.g., within a mile of the location). The user may provide preference information (e.g., stored in Event Manager-Specific Preferences field 608 of the subscription record in Subscription Table 602) for the proximity range in order to trigger the reminder.

Third party server 120 may be any third party server that ECP server 102 is in communication with that enables additional functionality of ECP server 102 and/or ECP application 114. For example, third party server 120 may be servers associated with third parties including, for example, online retailers. Because ECP computing device 102 is in communication with third party server 120, the user and/or event manager may directly access third party servers 120 through ECP application 114. For example, the user may access a third party server 120 by clicking a hyperlink that is included with the calendar event information input by an event manager (e.g., stored in Labels field 648) and displayed to the user in conjunction with the calendar event on the user's feed.

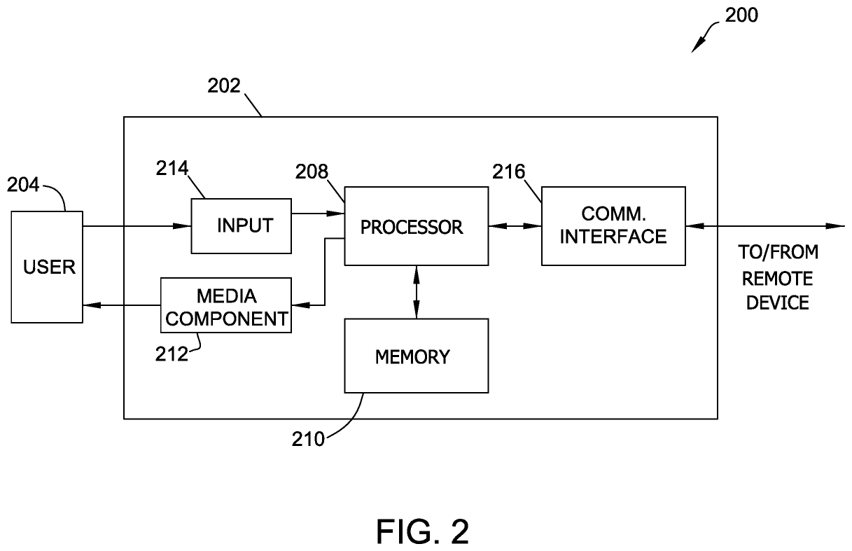

FIG. 2 illustrates an exemplary configuration 200 of an example computing device 202 that may be used to implement user computing device 104 and/or event manager computing device 106 (shown in FIG. 1). For example, computing device 202 may be a mobile device, smartphone, tablet, smartwatch, wearable electronic, laptop, desktop, or another type of computing device associated with the user and/or event manager.

Computing device 202 may be operated by a user 204. User 204 includes users and event managers that access ECP system 100 (shown in FIG. 1). Computing device 202 may receive input from user 204 via an input device 214. Computing device 202 includes a processor 208 for executing instructions. In some embodiments, executable instructions may be stored in a memory area 210. Processor 208 may include one or more processing units (e.g., in a multi-core configuration). Memory area 210 may be any device allowing information such as executable instructions and/or user and registration data to be stored and retrieved. Memory area 210 may include one or more computer-readable media.

Computing device 202 also may include at least one media output component 212 for presenting information to user 204. Media output component 212 may be any component capable of conveying information to user 204. Media output component 212 may be configured to present a graphical user interface (e.g., user interface 118 shown in FIG. 1) to user 204. The graphical user interface may display content from particular applications (e.g., ECP application 114 shown in FIG. 1) stored in memory area 210 and executed by processor 208. Content displayed on user interface 118 from ECP application 114 may include, for example, a calendar event feed, reminders, and notifications for the user and/or event managers, and/or a messaging page for interacting with the users and/or event managers.

Computing device 202 may also include input device 214 for receiving input from user 204. User 204 may use input device 214 to, without limitation, interact with ECP system 100 (e.g., using ECP application 114), ECP server 102, or any of computing devices 104 and 106 and third party servers 120 (shown in FIG. 1). Input device 214 may include, for example, a keyboard, a pointing device, a mouse, a stylus, and/or a touch sensitive panel (e.g., a touch pad or a touch screen) and may be used to at least partially implement user interface 118 (shown in FIG. 1). A single component, such as a touch screen, may function as both an output device of media output component 212 and input device 214. In some embodiments, at least some data collected by computing device 202 may be transmitted to ECP server 102. In the exemplary embodiment, data collected by computer device 202 may be included in user and event manager data.

Computing device 202 may also include a communication interface 216, communicatively coupled to any of ECP computing device 102, computing devices 104 and 106, and third party servers 120. Communication interface 216 may include, for example, a wired or wireless network adapter and/or a wireless data transceiver for use with a mobile telecommunications network.

Stored in memory area 210 may be, for example, computer-readable instructions for providing a user interface to user 204 via media output component 212 and, optionally, receiving and processing input from input device 214. The user interface may enable interaction with, among other possibilities, ECP application 114 implemented via a web browser and/or a client application. Web browsers enable users, such as user 204, to display and interact with media and other information typically embedded on a web page, a website, or an application hosted by ECP server 102. A client application may allow user 204 to interact with, for example, any of ECP server 102, computing devices 104 and 106, and third party servers 120. For example, instructions may be stored by a cloud service and the output of the execution of the instructions sent to the media output component 212. Computing device 202 may include additional, less, or alternate functionality, including that discussed elsewhere herein.

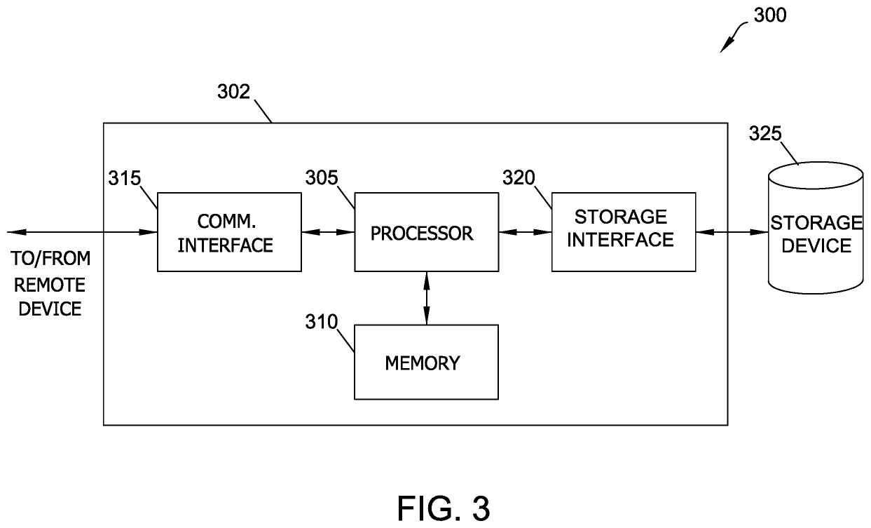

FIG. 3 depicts an exemplary configuration 300 of an example server computer device 302 that may be used to implement ECP server 102 (shown in FIG. 1). Server computer device 302 may include a processor 305 for executing instructions. Instructions may be stored in a memory area 310. Processor 305 may include one or more processing units (e.g., in a multi-core configuration).

Processor 305 may be operatively coupled to a communication interface 315 such that server computer device 302 may be capable of communicating with a remote device such as another server computer device 302 or a computing device, such as user computing device 104 and/or event manager computing device 106 (shown in FIG. 1). For example, communication interface 315 may receive requests from or transmit requests to computing devices 104 and 106 via the network 108.

Processor 305 may also be operatively coupled to a storage device 325. Storage device 325 may be any computer-operated hardware suitable for storing and/or retrieving data, such as, but not limited to, data associated with database 110 (shown in FIG. 1) and data structure 600 (shown in FIG. 6). In some embodiments, storage device 325 may be integrated in server computer device 302. For example, server computer device 302 may include one or more hard disk drives as storage device 325. In other embodiments, storage device 325 may be external to server computer device 302 and may be accessed by a plurality of server computer devices 302. For example, storage device 325 may include a storage area network (SAN), a network attached storage (NAS) system, and/or multiple storage units such as hard disks and/or solid state disks in a redundant array of inexpensive disks (RAID) configuration.

In some embodiments, processor 305 may be operatively coupled to storage device 325 via a storage interface 320. Storage interface 320 may be any component capable of providing processor 305 with access to storage device 325. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 320.

Processor 305 executes computer-executable instructions for implementing aspects of the disclosure. In some embodiments, processor 305 may be transformed into a special purpose microprocessor by executing computer-executable instructions or by otherwise being programmed.

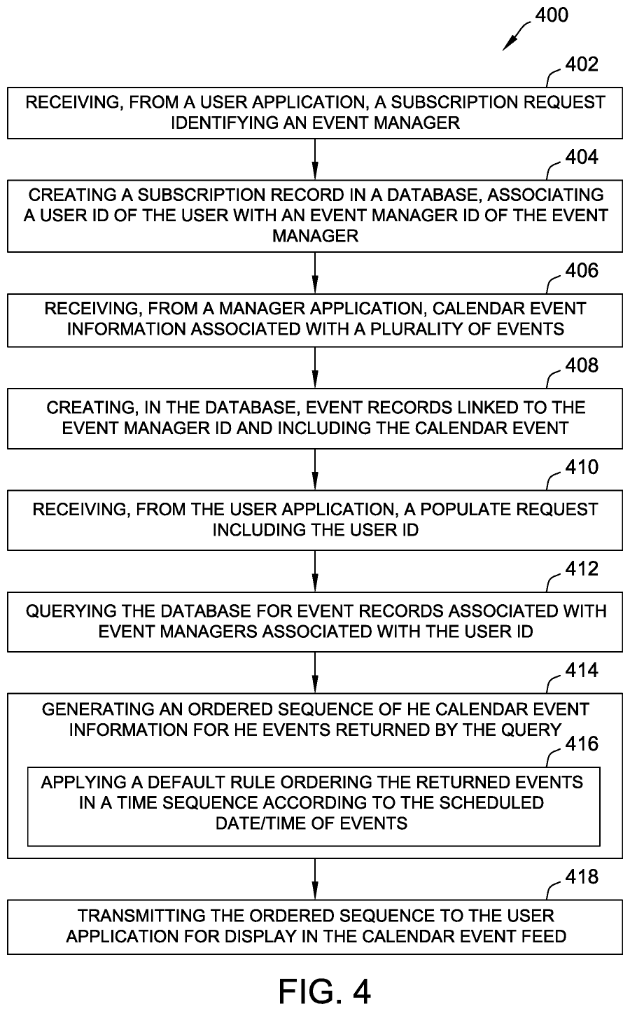

FIG. 4 depicts a flow diagram illustrating an example computer-implemented method 400 for presenting calendar event information on user interface 118 of user computing device 104. In the exemplary embodiment, method 400 may be implemented by ECP server 102.

In the example, method 400 includes receiving 402, from a user application (e.g., ECP application executing on user computing device 104, a subscription request identifying an event manager, and in response to the subscription request, creating 404 a subscription record in a database (e.g., database 110), the subscription record associating user ID of the user with an event manager ID of the event manager. Method 400 also includes receiving 406, from a manager application (e.g., ECP application 114) executing on event manager computing device 106, calendar event information associated with a plurality of events, the calendar event information including a scheduled date/time for each of the events, and creating 408, in database 110, a plurality of event records linked to the event manager ID, each event record of the plurality of event records including the calendar event information for a corresponding event of the plurality of events. Method 400 further includes receiving 410, from the user application, a populate request configured to populate a calendar event feed (e.g., calendar event feed 508 described below) displayed by the user application on the user computing device, the populate request including the user ID, and in response to the populate request, querying 412 the database for event records associated with event managers associated with the user ID. Additionally, method 400 includes generating 414 an ordered sequence of the calendar event information for the events returned by the query, including applying 416 a default rule ordering the returned events in a time sequence according to the scheduled date/time of the events, and transmitting 418 the ordered sequence to the user application for display in the calendar event feed. In some embodiments, method 400 includes additional or alternative steps consistent with the functionality described in the present disclosure.

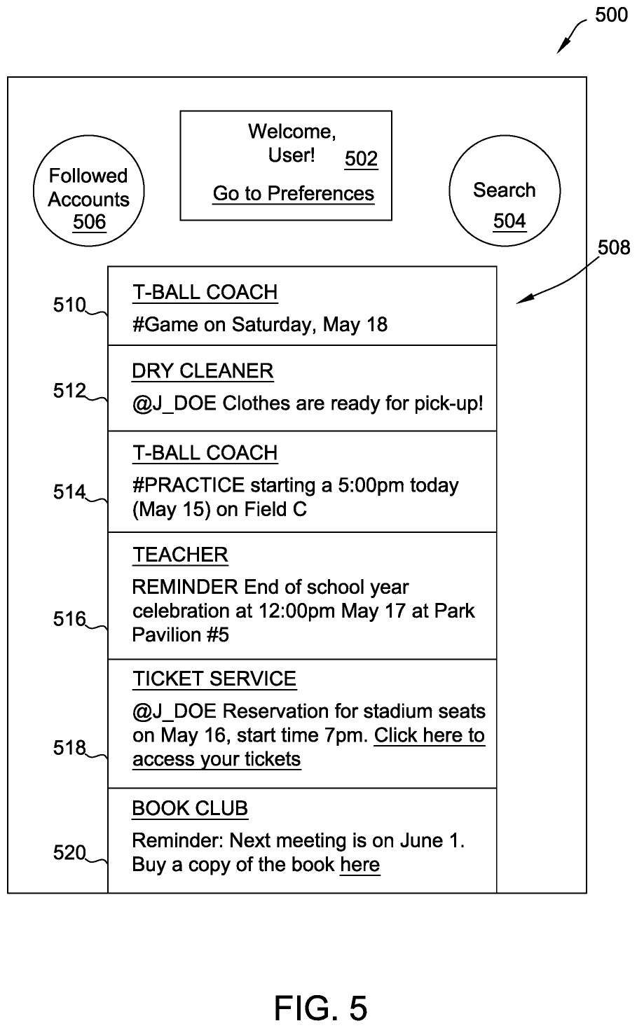

FIG. 5 illustrates an example screen 500 generated by ECP application 114 on user computing device 104 (shown in FIG. 1). Screen 500 may be displayed on and accessible via user interface 118 of user computing device 104 (shown in FIG. 1), which may be any suitable electronic device, such as a laptop, desktop, mobile phone, tablet, or any other computing device. Screen 500 may include a header 502, a search button 504, a followed accounts button 506, and a calendar event feed 508. Although not specifically shown, screen 500 may include any other buttons to help the user navigate the application. Header 502 may include a selectable prompt that causes the application to display a dialogue box or similar window that receives user input related to user preference information for, e.g., displaying calendar event information on calendar event feed 508. For example, the input user preference information is transmitted to ECP server 102, which stores the information in data structure 600 as shown in FIG. 6). Search button 504 is selectable by the user and causes the application to display a search bar that allows user to browse the ECP platform for, e.g., event manager accounts the user is interested in following. Followed accounts button 506 is selectable by the user and causes the application to display a list of event manager accounts that the user is following.

Calendar event feed 508 is populated with calendar event information previously input by event manager accounts that the user is following. As shown in FIG. 5, the calendar event information is displayed on calendar event feed 508 as an ordered list, or sequence, of event posts 510, 512, 514, 516, 518, 520. Event posts 510-520 are created from calendar event data previously input by one or more event managers, e.g. using their own instances of ECP application 114. As discussed above, the ordered sequence of event posts in feed 508 may be determined by ECP server 102 prior to transmission from ECP server 102 of the event data to populate calendar event feed 508. For example, when the user activates or refreshes ECP application 114, ECP application transmits a “populate” request to ECP server 102 to retrieve the ordered sequence of events from ECP server 102. ECP application 114 may also dynamically update or refresh calendar event feed 508, e.g., may periodically and automatically transmit “populate” requests to ECP server 102.

In response to the populate request, ECP server 102 queries database 110 for events created by event managers followed by the user. For example, with reference also to FIG. 6, ECP server 102 first queries Subscription Table 602 to find event managers followed by the user, and then queries the Event Table(s) 640 of the event managers identified in the first query for events. In some embodiments, to determine the ordered sequence for events returned by the query, ECP server 102 initially applies a default rule which orders events in time sequence according to the date/time of the scheduled event (e.g., as stored in Date/Time field 644 of the event record in Event Table 640). This is in contrast to conventional content feed-based applications, which typically order posts in a time sequence based on when the content was posted to the system by the content creator. ECP server 102 may then move some events up (or down) in the sequence based on event manager or user preferences, as described above, before transmitting the ordered sequence to ECP application 114 for populating feed 508. Moreover, ECP application 114 may alter the sequence provided by ECP server 102 by applying local filters selected by the user, as described above, to feed 508.

The example screen 500 illustrates some non-limiting uses of labels, as described above. For example, the user feed 508 is shown as it appears on May 15. Event post 514, which includes information related to a practice scheduled by a T-Ball Coach event manager, is assigned a #PRACTICE label by the event manager. In an absence of global or label-based user or event manager preferences, the #PRACTICE label assigned to the event does not alter the display of event post 514 according to default system rules, i.e., in regular time sequence in feed 508 according to the date/time of the scheduled practice, and regardless of when the event was created by the event manager. In another example, event post 510, which includes information related to a game scheduled by the T-Ball Coach event manager, is assigned a #GAME label by the event manager. In the example, based on user and/or event manager preferences, the #GAME label assigned to the event causes the application to elevate event post 510 to the top of feed 508, despite the actual event date being later in time than other events in feed 508. Thus, event post 510 is displayed in calendar event feed 508 with a higher priority, e.g., ahead of, event post 514, despite the fact that the event in post 514 occurs sooner in time than the event in post 510.

In another example, event post 516 includes information related to an end of year celebration scheduled by a Teacher event manager, who established a preference for posting reminders one day in advance. Based on an absence of conflicting user preferences, the event manager's reminder preference caused event post 516 to appear as a “REMINDER,” sequenced based on a time 24 hours before the actual event, in the sequence of feed 508. In other words, although the actual event referenced by post 516 occurs at noon on May 17, the separate REMINDER post 516 appears in feed 508 based on the 24-hour advance date/time of noon on May 16, ahead of event post 518 for an event at 7 pm on May 16. In some embodiments, after the REMINDER date/time (here, noon on May 16) passes, the event post then moves to a slot in feed 508 based on the actual event date/time (here, noon on May 17).

As described above, an event manager may also limit certain events to the feeds of particular followers of the event manager. For example, screen 500 is displayed by ECP application 114 of user Jane Doe, and event post 518, which includes information related to a stadium seat reservation created by Jane Doe through a Ticket Service event manager, includes a “@J_DOE” user tag that associates event post 518 solely with the user who created the stadium seat reservation. In other words, ECP application 114 displays, based on the user tag identified by the “@” prefix in Labels field 648, event post 518 on calendar event feed 508 of the UserID 620 specified after the tag, but does not display event post 518 on calendar event feeds associated with other users following the same event manager.

As described above, ECP application 114 may also monitor user location information and display event posts on calendar feed 508 based on a proximity of the user of user page 500 to a location of a scheduled event. For example, event post 512, which includes information related to a scheduled event for the user to pick-up clothes, may be created by a Dry Cleaner event manager followed by the user of user page 500. The event manager may create the event as soon as the clothes are ready, and set the scheduled date/time for, e.g., two weeks (or any suitable time) later to create a window for pick-up. ECP server 102 may then move the event up in the sequence of events submitted to ECP application 114 for use in feed 508 when the user is within a certain proximity to the location (e.g., the location stored in Location field 646 for the event record) of the scheduled pick-up event. The ECP application 114 may be in communication with a GPS or other location system to determine the current user location to determine when the user is in proximity of the dry cleaner. The user may provide preference information (e.g., stored in event manager-specific preferences field 608 of the subscription record) for the proximity range that the user must be within relative to the location of the scheduled pick-up event in order for event post 512 to be moved up on calendar event feed 508. While not specifically shown in FIG. 5, event post 512 may also include a prompt that allows the user to confirm that the scheduled pick-up event has been completed, and the application may remove event post 512 from calendar event feed 508 in response.

Events created by an event manager may also identify hyperlinks associated with a scheduled event. For example, information identifying the hyperlinks is stored in Labels field 648 of the corresponding event record in Event Table 640. When the calendar event information is transmitted by ECP server 102 for inclusion in feed 508, ECP application 114 displays those hyperlinks in the corresponding event posts. For example, event post 518 includes a hyperlink to the tickets of the stadium seat reservation created by the user through the Ticket Service event manager. The hyperlink may be selected by the user and causes ECP application 114 to display, or causes another application on the user computing device 104 to display, a web page of the Ticket Service event manager that includes the ticket information. In another example, event post 520, which is created by a Book Club event manager, includes a hyperlink to a third party online retailer web page that allows the user to purchase a book to read before the scheduled Book Club event.

Calendar event feed 508 provides several advantages over conventional calendar applications, in addition to being independent of local digital storage of the events. For example, conventional calendar applications require a user to click on a particular day or week of a monthly calendar to view information about the events scheduled for that day or week, and then that view shows only the events for the selected day or week. The user is forced through a series of manual clicks for different days/weeks/months in order to obtain a comprehensive understanding of the user's upcoming schedule. In contrast, calendar event feed 508 automatically allows the user to scroll through a single feed of all upcoming events in an ordered sequence, based primarily on time sequence but also prioritized based on user or event scheduler preferences, without being limited to viewing a single day or week at a time. Moreover, conventional calendar applications display a large amount of “white space,” i.e., time slots throughout the viewed day or week in which nothing is scheduled. In contrast, calendar feed 508 displays scheduled events directly adjacent to each other in a series, with no wasted “white space” in between scheduled events. This is particularly an advantage when user computing device 104 has a limited display area, for example on a smart phone, smart watch, other wearable computing device, or the like.

In some further embodiments, the ECP application 114 uses the calendar and calendar information as prospective data points to determine future locations and activities of the user. For example, if the user is scheduled to be at a baseball tournament in St. Louis the next weekend, the ECP application 114 is able to use that information to generate recommendations and provide targeted advertisements, coupons, and/or offers to the user. In the baseball tournament example, the ECP application 114 provides advertisements for nearby hotels, restaurants, attractions, etc. The ECP application 114 knows when and where the user will be. The ECP application 114 may also take into account the priorities of the user based on the choices that they have made in the past by the events that they have attended in the past. For example, if the user has prioritized attending their child's sporting events over attending dinners with friends, then the ECP application 114 will now provide advertisements more related to the location and times of the child's sporting events. In another example, the ECP application 114 knows the location of a child's soccer match and can serve advertisements related to a nearby ice cream shop to suggest the user take the child there afterwards.

The hyperlinks may be used to link to retail websites for providing different services and/or products. For example, a book club event may have a link to a website to purchase the next book to read. In another example, the hyperlink may link to a gallery of pictures that other users took at the last event. In a further example, a sports league event may have hyperlinks to the needed gear and/or equipment. This may include links to one or more e-commerce sites that have the different needed pieces of gear and/or equipment. These links may allow the user to build a shopping list. The links could also include documents that are needed to for the work meeting event. In some of these embodiments, the links are embedded in a QR code, so that the QR code may be shared with others that do not have the ECP application 114. The QR code can be printed, texted, emails, and otherwise shared with others. In the book club example, the QR includes a link to where the next book may be published.

In some further embodiments, the user's home page may include a QR code for them, that allows others to add the user as a friend or contact in the ECP application 114.

In additional embodiments, a user may have separate calendars for work and personal. For example, a user is the event manager for a performing arts venue. They manage the events and the event manager for that venue, but they also have a personal calendar that may be separate from the performing arts event manager. Although they may follow the venue's event manager to be able to track the events on their personal calendar.

In the exemplary embodiment, the ECP application 114 may follow persons, places, and things, such as, but not limited to, corporations, clubs, and/or organizations.

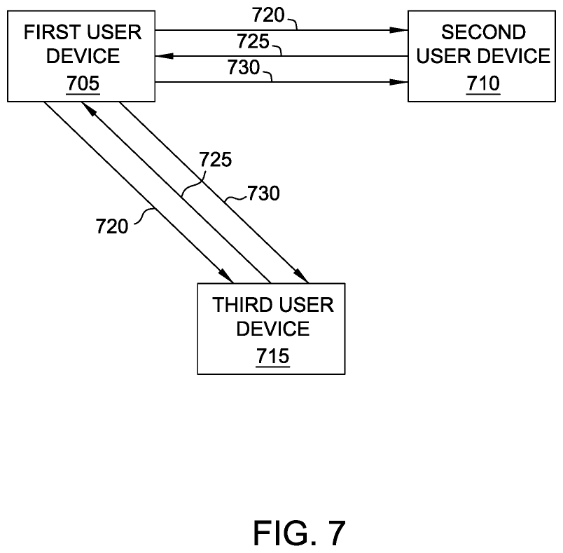

FIG. 7 illustrates an example system 700 for synchronizing multiple calendars to schedule one or more events using the electronic calendar platform computer system 100 (shown in FIG. 1). In the exemplary embodiment, a plurality of user computing devices 104 (shown in FIG. 1) may be in communication through the ECP application 114 (shown in FIG. 1) to synchronize the calendars associated with those user computing device 104 to determine when to schedule one or more events. The goal with synchronizing calendars is to allow a user to press a button and synchronize schedules with one or more other users to determine the best time(s) to schedule one or more events. The event may be a single event, such as a meeting or the event may be several events, such as the best night for a weekly dinner meeting and/or game night. The event synchronization may also be used for making a work schedule and determining which individuals to schedule for different shifts at work. In one example, a boardroom full of 20 people may synchronize their calendars to determine when they can set-up their next meeting.

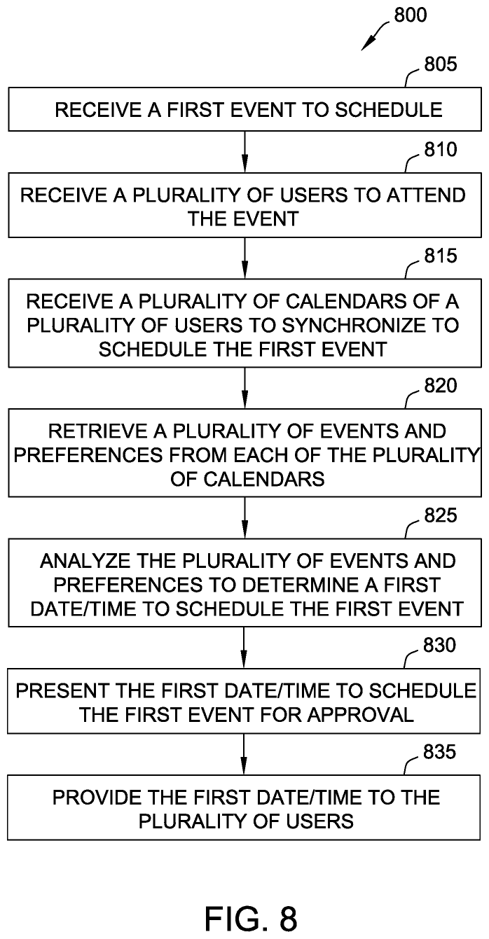

In the exemplary embodiment, a first user has a first user device 705, which may be a user computing device 104, with the ECP application 114. The first user device 705 is in communication with one or more other user computing devices 104, such as second user device 710 and third user device 715. In some embodiments, the first user device 705, the second user device 710, and the third user device 715 are in communication with each other through wired or wireless communications. In at least one embodiment, the first, second, and third user devices 705, 710, and 715 are in communication via Bluetooth, Wi-Fi, and/or NFC (Near Field Communications. The first user activates the sync process 800 (shown in FIG. 8), such as by pressing a button in the ECP application 114 or by a verbal command. The ECP application 114 sends calendar requests 720 to the ECP applications 114 of the other user devices 710 and 715. The calendar requests 720 include information including a desired date range for the event, such as the next week, the next month, etc. The other user devices 710 and 715 reply with their calendar information 725 including events that the corresponding user has scheduled and any preferences that the user has. The first user device 705 then compares the calendar information 725 for the first, second, and third user devices 705, 710, and 715 to determine the appropriate time and date for the event. In some embodiments, the first user device 705 selects the first available date and time. In other embodiments, the first user device 705 has other preferences that it takes into account. The first user may then decide to reject the provided date and time and request another date and time from the first user device 705. When the first user accepts a date and time for the event, the first user device 705 transmits the event date/time 730 to the second and third user devices 710 and 715 where their ECP applications 114 add the event date/time 730 to their calendars.

In some embodiments, the first user device 705 may also add in user computing devices 104 that are not present and are not connected to the first user device 705 via a wireless connection. These other user computing device 104 may be connected to the ECP application 114 of the first user device 705, such as by being contacts and/or friends of the first user and connected to the first user's calendar. In these embodiments, the first user device 705 may transmit the calendar request 720 to the ECP server computing device 102 (shown in FIG. 1). The ECP server computing device 102 transmits the calendar information 725 for the requested user to the first user device 705. When the event date/time 730 is selected, the first user device 705 transmits the event date/time 730 to the calendar of the added user and the event is added to the added user's calendar.

In some other embodiments, the first user may remove individuals from the event request 720. This may be for individuals that are wirelessly connected to the first user device 705, but will not be attending the event. Furthermore, the user of the second and third user device 710 and 715 may receive an option to decline joining the event. When the calendar request 720 is receive, the user interface 118 (shown in FIG. 1) may provide a pop-up or other notification to allow the corresponding user to decline to be a part of the event. The user may also be able to decline the event after the event date/time 730 is received.

In the shift scheduling embodiment, the first user device 705 determines one or more work schedules that will work based on the events and preferences of the workers. The first user device 705 takes into account events of the workers including both those that directly conflict with shifts, such as medical appointments, as well as those that may indirectly impact shifts, such as a worker attending a late-night concert and thus not being scheduled for an early morning shift or a worker attending a concert or event starting at 8 PM and thus not being scheduled to work until 7:30 PM. In some embodiments, the first user device 705 ensures that each worker has a sufficient amount of time for rest before each shift. The first user device 705 may also take into account laws and regulations associated with the industry to ensure that workers work the proper shifts, such as not scheduling minors to work after a particular hour, etc.

While the above describes the processing of the event occurring at the first user device 705, in some embodiments, the processing for determining when to schedule the event may occur at the ECP server computing device 102.

In some embodiments, the first user device 705 determines the event date/time when all of the users can attend. In case there is no acceptable time when all of the users can attend, the first user device 705 determines when the most users may attend. In some embodiments, different users may have different priorities for attending the event, such that it is more important for the CEO to attend than one or more of the board members. In some of these embodiments, the first user device 705 determines when a quorum of users may attend.

FIG. 8 illustrates an exemplary process 800 for synchronizing multiple calendars to schedule one or more events using the system 700 (shown in FIG. 7). The steps of process 800 may be performed by one or more a user computer devices 104 (shown in FIG. 1), such as first user device 705 (shown in FIG. 7) being used by a first user or the ECP server computing device 102 (shown in FIG. 1). Process 800 may be used to set-up a single event, multiple events, a series of events, and/or work schedules.

In the exemplary embodiment, the first user device 705 receives 805 a first event to schedule. The first event may be for a meeting, a dinner club, a lunch, a social event, and/or any other event where multiple people's calendars need to be synchronized to determine times when everyone is available for the first event. In some embodiments, the first event has one or more parameters for the set-up of the event. For example, for a book club, the meeting may only be between different hours in the day (e.g., between 10 AM and 3 PM) and only on specific days (e.g., Monday through Thursday). In another example, parameters include every Thursday in the next month and the first user device 705 finds a time for each Thursday that the event may occur. This may be the same time each week.

The first event may also have a location set, where the location has its own calendar. For example, the Franklin Room at the local library, in which case the first user device 705 includes the public library's room reservation schedule in the list of those calendars to be consulted.

The first user device 705 receives 810 a plurality of users to attend the event. The users may be physically close to the first user, such that their user computing devices 104 are in wireless communication with the first user device 705. In some embodiments, the first user device 705 adds users to and/or removes users from the plurality of users. For example, the first user device 705 removes a user that will not be able to attend the event. In another example, the first user device 705 adds one or more users that are not a part of the initial list of the plurality of users. For example, these additional users may not be physically present, but are added from contacts and/or friends lists of the first user.

For each of the plurality of users, the first user device 705 receives 815 a calendar to synchronize their schedules for the first event. This may be in response to an event request 720 (shown in FIG. 7) from the first user device 705. The plurality of calendars include calendar information 725 for each of the users. The calendar information includes events already scheduled for the corresponding users and parameters and preferences for the different users. The parameters may include times when the user is unavailable and priorities of different event types. For example, some events may just be informational events, such as the schedule of a sports team or performing arts center. These informational events may be scheduled over and the parameters and preferences of the user inform the first user device 705 which of the events in their calendar may be considered non-binding or non-blocking and which events cannot be scheduled over.

The first user device 705 retrieves 820 a plurality of events and preferences from each of the plurality of calendars. In some embodiments, the entire calendar or relevant section of the calendar is transmitted to the first user device 705. In other embodiments, the user computing devices 104 transmit access to one or more online databases 110 (shown in FIG. 1) where the calendar information 725 is stored for each of the plurality of users.

The first user device 705 analyzes 825 the plurality of events and preferences to determine a first event date/time 730 for the first event. The first user device 705 compares the calendar information 725 for all of the users including the first user to determine the appropriate time and date for the first event. In some embodiments, the first user device 705 selects the first available date and time. In other embodiments, the first user device 705 has other preferences that it takes into account. The first user device 705 presents 830 the first event date/time 730 to the first user via the first user device 705. The first user may then decide to reject the provided date and time and request another date and time from the first user device 705. Steps 825 and 830 continue until the first user accepts a date and time for the first event.

If the first user approves the first event date/time 730, the first user device 705 provides 835 the first event date/time 730 to the plurality of users. In these embodiments, the first user device 705 transmits the first event date/time 730 to the user computing devices 104 of the plurality of users to add to the user's calendar. In some embodiments, a notification is presented to each of the plurality of users informing them of the first event and the first event date/time 730. In further embodiments, the individual users are given the option to approve and/or deny the first event. Furthermore, the users are given an option to set the first event as tentative.

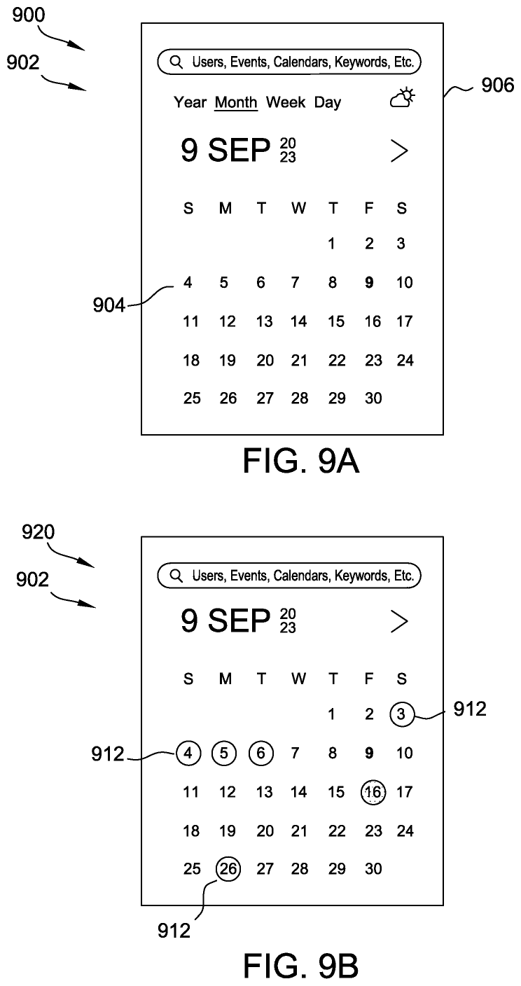

FIGS. 9A and 9B illustrate screenshots 900 and 910 of an exemplary calendar 902 for the electronic calendar platform computer system 100 (shown in FIG. 1). In the exemplary embodiment, the calendar 902 includes a plurality of dates 904. The calendar also includes a plurality of calendar types 906, such as, but not limited to, work, medical, sports, family, and any other that the user desires. Each event is associated with a calendar type 906. The user may set-up the different calendar types to provide different types of information. Furthermore, the user may customize the calendar types to be associated with different colors, so that the user may easily determine the calendar type for different events. For example, blue may be associated with work, and any events highlighted with a blue highlight 912 would be work events, such as work meetings. In another example, green may be associated with medical, and any events highlighted with a green highlight 912 would be medical events, such as doctor appointments. In a further example, red may be associated with a child's events, such as baseball, soccer, and/or chess club. The events highlighted in red may be practices, games, and/or tournaments for the child. By highlighting the events with a different color based on the event type 906, the user may easily determine the type of event. While the highlights 912 are shown as circles around the dates 904 in FIG. 9B, one having skill in the art would understand that other display methods may be used for displaying the event types 906. For example, the event types 906 may be displayed as dots near the corresponding date 904. In another example, the numbers for the dates 904 may be filled in of the appropriate color. In some embodiments, there may be a large number of events associated with a date 904 and the system 100 may only show a predetermined number of those highlights 912. The predetermined number may be set by the user as a preference. Furthermore, the different event types 906 may have different priorities as set by the user. For example, work and medical events may have a higher priority than professional sports team events. In one example, the different priorities are low, medium, high, and informational. Different events may automatically override events of lower priority based on the user's preferences.

In some further embodiments, the highlight 912 may indicate the number of events of the event type 906. For example, there may be a dot for each of the events of a specific event type 906. In another example, the circle and/or dot may be a darker shade and/or thicker based on the number of events of that event type 906 on the particular date 904. These changes may be based on relative numbers of those events and/or absolute numbers of those events.

In the exemplary embodiment, the user may also filter the events displayed on the calendar 902 by event type 906. In this matter, the user may have the system 100 only display events of a particular type and/or not display events of another type. For example, the user may display the work events and their child's events to determine information about their month/week/day/morning/afternoon/evening. In addition, the user may also may have event types 906 that are for information only. This may include sporting events, concerts, store and/or restaurant events, and/or any other event type 906 that the user would like to track. In the exemplary embodiment, these information only event types 906 are also provided by event managers.

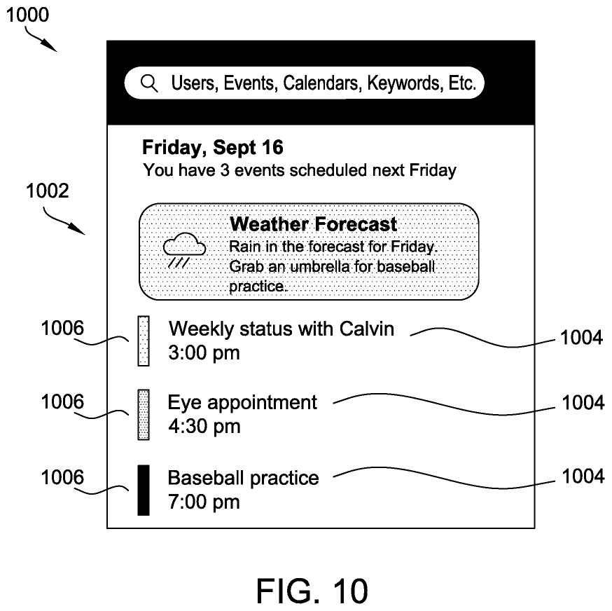

FIG. 10 illustrates a screenshot 1000 of an exemplary event list 1002 for a specific day for the electronic calendar platform computer system 100 (shown in FIG. 1). On event list 1002, there are plurality of event listings 1004 for the particular day. Each event listing 1004 has a corresponding highlight color 1006. These highlight colors 1006 are based on the event type 906 (shown in FIG. 9) as described above. By selecting and/or clicking on an individual event listing 1004, the user may learn more information about the event that corresponds to the event listing.

In some embodiments, the event list 1002 may include other information about the day including, but not limited to, weather forecasts, to-do lists, sports scores, news items (local, national, global), trivia, and/or any other information that the user prefers. This information may be set by the user via one or more preferences.

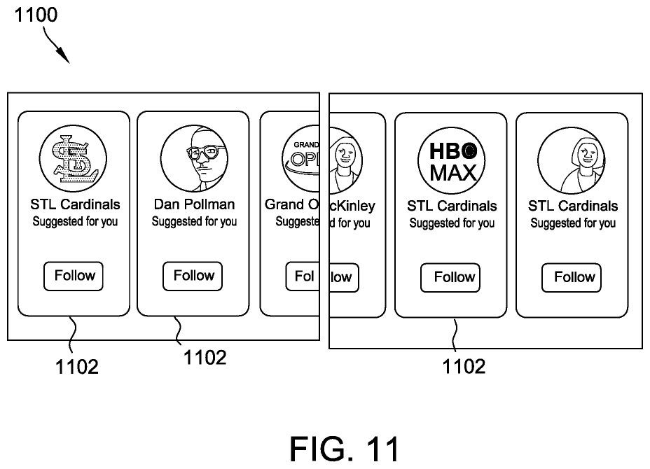

FIG. 11 illustrates a screenshot 1100 of a list of event managers 1102 to be followed on the electronic calendar platform computer system 100 (shown in FIG. 1). By selecting one of the event managers 1102, the user may see more information about the corresponding event manager and the events that that event manager provides. The user may select to follow that event manager and receive events and other information about the event manager. For example, a sports team event manager may provide events of when the team is playing at home or away, as well as events where the team and/or mascot are going to attend. A sports star's event manager may provide events of when the star is having a meet and greet with fans. A streaming service may provide events about when different shows are available for viewing.

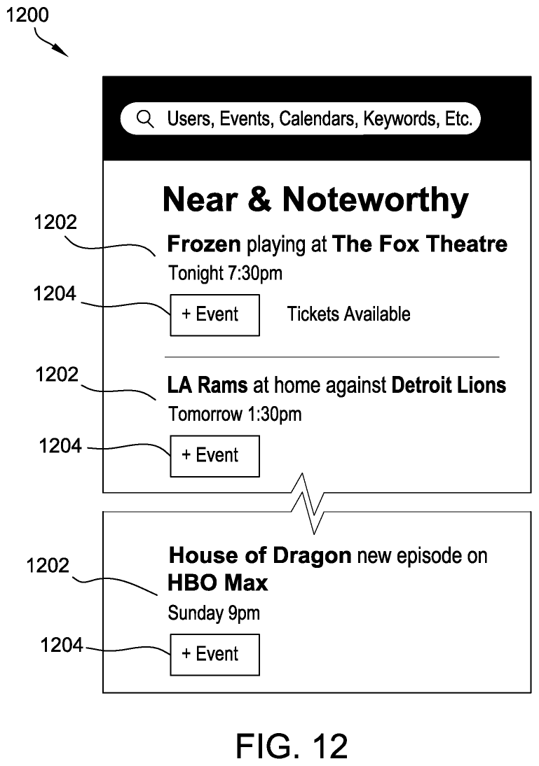

FIG. 12 illustrate a screenshot 1200 of a near and noteworthy feature of the electronic calendar platform computer system 100 (shown in FIG. 1). In the near and noteworthy feature, the system 100 provides information about different events that are occurring near the user. This may be based on a GPS location of the user via their user computer device 104 (shown in FIG. 1) and/or where the location is set by user preferences, such as where their home is or that they are on a trip. These may also be provided based on past events that the user has attended etc. For each event, there is an event description 1202 and a button 1204 to allow the user to add the event to their calendar. The event description 1202 may be provided by the event manager when adding the event.

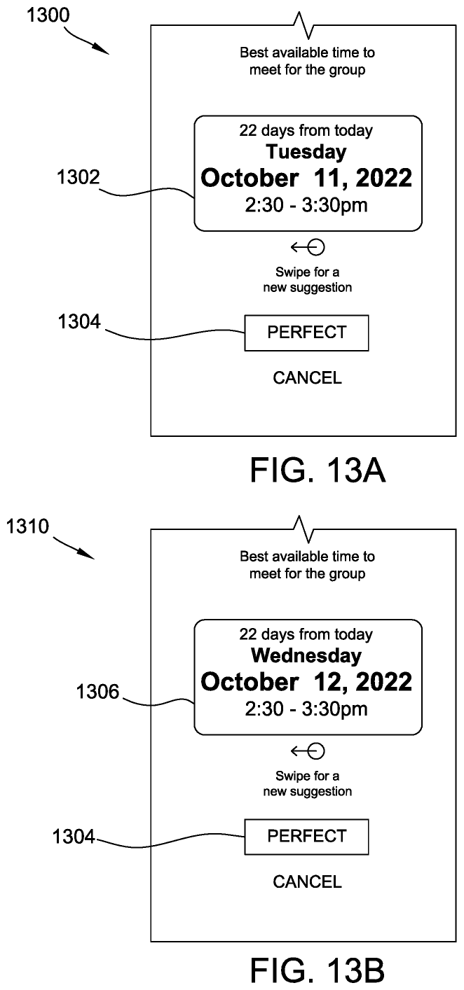

FIGS. 13A and 13B illustrate screenshots 1300 and 1310 of a calendar sync feature of the electronic calendar platform computer system 100 (shown in FIG. 1) using the process 800 (shown in FIG. 8). In the exemplary embodiment, screenshot 1300 shows a view of a date and time for an event as provided by the calendar sync process 800. The screenshot 1300 shows a date/time combination 1302 for the event based on the evaluation of the calendars of the other users and one or more parameters of the event. The screenshot 1300 also includes an approve button 1304 and a cancel button 1306. In the exemplary embodiment, the user may swipe the date/time combination 1302 to receive a different date/time combination 1308, such as that shown in the second screenshot 1310. In some embodiments, the first date/time combination 1302 is the first available time for the event and the second date/time combination 1308 is the next available time for the event. The user may continue to swipe to receive additional date time combinations. In some embodiments, the user may swipe left and right to receive earlier and/or later date/time combinations 1302. For example, the user may swipe left twice to get to the second date/time combination 1308 and then swipe right twice to return to the first date/time combination 1302. When the user arrives at a desired date/time combination 1302, the user can press the accept (labeled “perfect”) button 1304 to set the date and time for the event. The user may also press the cancel button 1306 to stop setting up the event.

The computer systems and computer-implemented methods discussed herein may include additional, less, or alternate actions and/or functionalities, including those discussed elsewhere herein. The computer systems may include or be implemented via computer-executable instructions stored on non-transitory computer-readable media. The methods may be implemented via one or more local or remote processors, transceivers, servers, and/or sensors (such as processors, transceivers, servers, and/or sensors mounted on mobile computing devices, or associated with smart infrastructure or remote servers), and/or via computer executable instructions stored on non-transitory computer-readable media or medium.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another embodiment, a computer program is provided, and the program is embodied on a computer-readable medium. In an exemplary embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). In still yet a further embodiment, the system is run on Android® OS (Android is a registered trademark of Google, Inc. of Mountain View, Calif.). In another embodiment, the system is run on Linux® OS (Linux is a registered trademark of Linus Torvalds of Boston, Mass.). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or step recited in the singular and proceeded with the word “a” or “an” should be understood as not excluding plural elements or steps, unless such exclusion is explicitly recited. Furthermore, references to “exemplary embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to illustrate the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electronic calendar platform (“ECP”) server including at least
one processor in communication with at least one memory device, the at least one processor programmed to:
receive, from a user application executing on a user computing device, a subscription request identifying an event manager;
in response to the subscription request, create a subscription record in a database, the subscription record associating a user ID of a user with an event manager ID of the event manager;
receive, from a manager application executing on an event manager computing device, calendar event information associated with a plurality of events, the calendar event information including a scheduled date/time for each of the events;
create, in the database, a plurality of event records linked to the event manager ID, each event record of the plurality of event records including the calendar event information for a corresponding event of the plurality of events;
receive, from the user application, a populate request configured to populate a calendar event feed displayed by the user application on the user computing device, the populate request including the user ID;
in response to the populate request, query the database for event records associated with event managers associated with the user ID;
generate an ordered sequence of the calendar event information for the events returned by the query, including applying a default rule ordering the returned events in a time sequence according to the scheduled date/time of the events; and
transmit the ordered sequence to the user application for display in the calendar event feed.

2. The ECP server of claim 1, wherein the at least one processor is further programmed to:
associate global preference information of the user with the user ID in the database; and
subsequent to applying the default rule and prior to transmitting the ordered sequence, update the ordered sequence by moving at least one of the events based on the global preference information of the user.

3. The ECP computer system of claim 1, wherein the at least one processor is further programmed to:
include event manager-specific preference information of the user in the subscription record; and
subsequent to applying the default rule and prior to transmitting the ordered sequence, update the ordered sequence by moving at least one of the events based on the event manager-specific preference information.

4. The ECP server of claim 1, wherein the at least one processor is further programmed to:
associate global preference information of the event manager with the event manager ID in the database; and
subsequent to applying the default rule and prior to transmitting the ordered sequence, update the ordered sequence by moving at least one of the events based on the global preference information of the event manager.

5. The ECP server of claim 1, wherein the calendar event information received from the event manager includes a label associated with one of the events, wherein the at least one processor is further programmed to:
subsequent to applying the default rule and prior to transmitting the ordered sequence, update the ordered sequence by moving the one of the events based on the label.

6. The ECP server of claim 1, wherein the calendar event information received from the event manager includes a user tag associated with one of the events, wherein the at least one processor is further programmed to include the one of the events in the ordered sequence only if the user tag identifies the user ID.

7. The ECP server of claim 6, wherein the at least one processor is further programmed to:
associate a reminder preference in the database with at least one of the user ID, the event manager ID, and the subscription record, the reminder preference including a reminder time period; and
subsequent to applying the default rule and prior to transmitting the ordered sequence, move one of the events forward in the time sequence by the reminder time period.

8. The ECP server of claim 1, wherein the calendar event information received from the event manager identifies a hyperlink associated with one of the events, and wherein the ordered sequence of calendar event information causes the user application to display the hyperlink in an event post for the one of the events.

9. The ECP server of claim 1, wherein the calendar event information includes a location for each of the events, wherein the populate request includes location data of the user computing device, and wherein the at least one processor is further programmed to:
determine, based on the location data, that the user is within a proximity distance of the location of one of the events; and
subsequent to applying the default rule and prior to transmitting the ordered sequence, update the ordered sequence by moving the one of the events based on the proximity distance determination.

10. The ECP server of claim 1, wherein the at least one processor is further programmed to:
receive, from the event manager application, a push request configured to users following the event manager of an event update, the push request including the event manager ID and calendar event information for the event update;
in response to the push request, query the database for subscription records associated with the event manager ID; and
transmit the calendar event information for the event update to user computing devices associated in the database with the user IDs in the subscription records returned by the query.

11. The ECP server of claim 10, further comprising the database, wherein the subscription record includes a user ID field storing the user ID and an event manager ID field storing the event manager ID, wherein the subscription record is stored in a subscription table, and wherein the subscription table is indexed on both the user ID field and the event manager ID field.

12. The ECP server of claim 1, further comprising the database, wherein the database comprises:
a user table storing a plurality of user IDs including the user ID;
an event manager table storing a plurality of event manager IDs including the event manager ID;
a subscription table storing a plurality of subscription records including the subscription record; and
an event table storing the plurality of event records.

13. The ECP server of claim 1, wherein the database further comprises a plurality of event tables, wherein each of the event tables is linked to a corresponding one of a plurality of event manager IDs.

14. The ECP server of claim 1, wherein the at least one processor is further programmed to:
receive a first event to be scheduled;
receive a plurality of event records associated with a plurality of users;
compare the plurality of event records to determine a date/time combination for the first event; and
provide the determined date/time combination to the plurality of users.

15. The ECP server of claim 14, wherein the first event includes one or more parameters and the at least one processor is further programmed to determine the date/time for the event in view of the one or more parameters.

16. The ECP server of claim 14, wherein the at least one processor is further programmed to:
receive a plurality of preferences from the plurality of users; and
determine the date/time for the event in view of the plurality of preferences.

17. The ECP server of claim 14, wherein the at least one processor is further programmed to provide a plurality of date/time combinations for the first event to a first user for approval.

18. A computer-implemented method performed by an electronic calendar platform (“ECP”) server including at least one processor in communication with at least one memory device, the computer-implemented method comprising steps performed by the at least one processor of:
receiving, from a user application executing on a user computing device, a subscription request identifying an event manager;
in response to the subscription request, creating a subscription record in a database, the subscription record associating a user ID of a user with an event manager ID of the event manager;
receiving, from a manager application executing on an event manager computing device, calendar event information associated with a plurality of events, the calendar event information including a scheduled date/time for each of the events;
creating, in the database, a plurality of event records linked to the event manager ID, each event record of the plurality of event records including the calendar event information for a corresponding event of the plurality of events;
receiving, from the user application, a populate request configured to populate a calendar event feed displayed by the user application on the user computing device, the populate request including the user ID;
in response to the populate request, querying the database for event records associated with event managers associated with the user ID;
generating an ordered sequence of the calendar event information for the events returned by the query, including applying a default rule ordering the returned events in a time sequence according to the scheduled date/time of the events; and
transmitting the ordered sequence to the user application for display in the calendar event feed.

19. The computer-implemented method of claim 18, further comprising:
associating global preference information of the user with the user ID in the database; and
subsequent to applying the default rule and prior to transmitting the ordered sequence, updating the ordered sequence by moving at least one of the events based on the global preference information of the user.

20. The computer-implemented method of claim 18, further comprising:
including event manager-specific preference information of the user in the subscription record; and
subsequent to applying the default rule and prior to transmitting the ordered sequence, updating the ordered sequence by moving at least one of the events based on the event manager-specific preference information.

21. The computer-implemented method of claim 18, further comprising:
associating global preference information of the event manager with the event manager ID in the database; and
subsequent to applying the default rule and prior to transmitting the ordered sequence, updating the ordered sequence by moving at least one of the events based on the global preference information of the event manager.

22. The computer-implemented method of claim 18, wherein the calendar event information received from the event manager includes a label associated with one of the events, further comprising:
subsequent to applying the default rule and prior to transmitting the ordered sequence, updating the ordered sequence by moving the one of the events based on the label.

23. The computer-implemented method of claim 18, wherein the calendar event information received from the event manager includes a user tag associated with one of the events, further comprising including the one of the events in the ordered sequence only if the user tag identifies the user ID.

24. At least one non-transitory computer-readable medium comprising instructions embodied thereon, the instructions executable by at least one processor of an electronic calendar platform (“ECP”) server to cause the at least one processor to:
receive, from a user application executing on a user computing device, a subscription request identifying an event manager;
in response to the subscription request, create a subscription record in a database, the subscription record associating a user ID of a user with an event manager ID of the event manager;
receive, from a manager application executing on an event manager computing device, calendar event information associated with a plurality of events, the calendar event information including a scheduled date/time for each of the events;
create, in the database, a plurality of event records linked to the event manager ID, each event record of the plurality of event records including the calendar event information for a corresponding event of the plurality of events;
receive, from the user application, a populate request configured to populate a calendar event feed displayed by the user application on the user computing device, the populate request including the user ID;
in response to the populate request, query the database for event records associated with event managers associated with the user ID;
generate an ordered sequence of the calendar event information for the events returned by the query, including applying a default rule ordering the returned events in a time sequence according to the scheduled date/time of the events; and
transmit the ordered sequence to the user application for display in the calendar event feed.
